(19) United States
(12) Patent Application Publication
(10) Pub. No.: US 2020/0219072 A1
(43) Pub. Date: Jul. 9, 2020

(54) SERVER, METHOD, AND RECORDING MEDIUM STORING COMMANDS FOR SUPPORTING PAYMENT

(71) Applicant: HYUNDAI CARD CO., LTD., Seoul (KR)

(72) Inventors: Jun Won KO, Seoul (KR); Ji Won OH, Seoul (KR); Dong Jo KOH, Seoul (KR); Yeon Joo PARK, Seoul (KR); Yu Kyung CHOI, Seoul (KR); Dong Hyuk SHIN, Seoul (KR); Yoo Kyung PARK, Seoul (KR); Hyung Woo CHOI, Seoul (KR)

(21) Appl. No.: 16/733,974

(22) Filed: Jan. 3, 2020

(30) Foreign Application Priority Data
Jan. 4, 2019 (KR) 10-2019-0001188
Mar. 15, 2019 (KR) 10-2019-0030099

(51) Int. Cl. G06Q 20/10; G06Q 20/20; G06Q 20/04; G06Q 20/32; G06Q 50/12

(52) U.S. Cl. CPC G06Q 20/102; G06Q 20/20; G06Q 50/12; G06Q 20/3278; G06Q 20/0453

(57) ABSTRACT

The present disclosure proposes a server that supports payments of a plurality of users. The server may acquire first payment information from a first terminal, request a payment server to process a first payment, deliver sales information and payment status information to a shop terminal and terminals of the remaining users, deliver the payment status information to the first terminal, acquire second payment information from a second terminal, request the payment server to process a second payment, deliver updated payment status information to the terminals, deliver a first notification indicating that the payment of the total amount has been completed to the shop terminal, acquire a second notification indicating confirmation of the payment completion from the shop terminal, and deliver a third notification indicating confirmation of the payment completion to the terminals of the plurality of users.

### CROSS-REFERENCE TO RELATED APPLICATIONS

This application is based upon and claims the benefit of priority from Korean Patent Application No. 10-2019-0001188, filed on Jan. 4, 2019, and Korean Patent Application No. 10-2019-0030099, filed on Mar. 15, 2019, the entire contents of which are incorporated herein by reference.

### TECHNICAL FIELD

The present disclosure relates to a technique for supporting payments.

### BACKGROUND

Recently, for the convenience of users, a technique for easily making payments has been introduced into the market. However, in order to make a payment in a food service shop (e.g., a restaurant), there is still an inconvenience of having to go to a checkout counter of the shop after a meal to make the payment. At crowded lunch time or the like, customers may have to wait in line to pay at the checkout counter. Also, even when a customer calls a clerk to make a payment at a table where the customer has eaten, the customer may still experience the inconvenience having to wait for the clerk to process the payment.

Such inconvenience may be further exacerbated when several people share the payment by splitting the bill in a so-called Dutch pay method. When several customers pay their respective amounts through bill splitting according to the Dutch pay method, a payment process must be repeated several times, and thus the customers may have to wait a long time at the checkout counter or table. Also, when the total payment is divided into different amounts, when it is necessary to include a tip to be paid to a clerk (a waiter, etc.), or when a discount is applied through a coupon or the like, a calculation process for dividing the total payment may be complicated, and this may further increase the amount of time that customers spend waiting at a checkout counter or table.

### SUMMARY

Various embodiments of the present disclosure provide a technique for supporting payments.

In one aspect of the present disclosure, a server for payment support may be proposed. The server according to one aspect of the present disclosure may be a server for supporting payments of a total amount to be paid which is spent by a plurality of users in an offline shop. The server according to an aspect of the present disclosure may include one or more processors and one or more memories storing commands that cause the one or more processors to perform an operation when the commands are executed by the one or more processors, wherein the one or more processors may acquire, from a first terminal of a first user among the plurality of users, sales information indicating the shop, an identifier for identifying a group of the plurality of users, and the total amount to be paid, invitation information for identifying the remaining users excluding the first user among the plurality of users, and first payment information indicating a first payment amount corresponding to a portion of the total amount to be paid, request a payment server to process a first payment of the first payment amount by the first user based on the first payment information, deliver the sales information and payment status information for the total amount to be paid to a shop terminal of the shop and terminals of the remaining users, and deliver the payment status information to the first terminal according to a response from the payment server indicating that the first payment has been approved, wherein the payment status information indicates a total paid amount or a total remaining unpaid amount out of the total amount to be paid, acquire second payment information indicating a second payment amount corresponding to a portion of the remaining unpaid amount out of the total amount to be paid from a second terminal of a second user among the remaining users, request the payment server to process a second payment of the second payment amount by the second user based on the second payment information, update and deliver the payment status information to the shop terminal and the terminals of the plurality of users according to a response from the payment server indicating that the second payment has been approved, deliver a first notification indicating that the payment of the total amount to be paid has been completed to the shop terminal and the terminals of the plurality of users when the payment of the total amount to be paid is completed, acquire a second notification indicating that the payment completion for the total amount to be paid is confirmed from the shop terminal, and deliver a third notification indicating that the payment completion for the total amount to be paid is confirmed to the terminals of the plurality of users upon a receipt of the second notification.

In an embodiment, the one or more processors may deliver a notification indicating that the first payment has been completed to the first terminal according to a response from the payment server indicating that the first payment has been approved, and deliver a notification indicating that the second payment has been completed to the second terminal according to a response from the payment server indicating that the second payment has been approved.

In an embodiment, the one or more processors may acquire, from the shop terminal, designated-user information for identifying a designated user, acquire, from at least one of the first terminal, the second terminal and the invitation information, user identification information for at least one of the plurality of users, and determine the designated user corresponding to the shop among the plurality of users based on the designated-user information and the user identification information.

In an embodiment, the one or more processors may acquire, from the shop terminal, designated-user information related to at least one of a payment number condition, a payment amount condition and a payment frequency condition of a designated user, acquire, from at least one of the first terminal, the second terminal, and the invitation information, user identification information for at least one of the plurality of users, acquire, from the one or more memories, payment history information for the shop of the at least one of the plurality of users based on the user identification information, and determine the designated user corresponding to the shop among the plurality of users based on the payment history information and the designated-user information.

In an embodiment, the one or more processors may acquire, from the shop terminal, information relating to a product of the shop that corresponds to the total amount to be paid, and deliver, to a terminal of the designated user, coupon information of the shop that relates to the product.

In an embodiment, the one or more processors may acquire, from the shop terminal, information indicating a first application probability, a first discount rate, a second application probability higher than the first application probability, and a second discount rate higher than the first discount rate to apply a discount to a payment amount for the shop; in response to the acquisition of the second payment information, apply the first discount rate to the second payment amount according to the first application probability when the second user is not the designated user, and apply the second discount rate to the second payment amount according to the second application probability when the second user is the designated user; and request the payment server to process a payment of the second payment amount to which the first discount rate or the second discount rate is applied.

In an embodiment, the one or more processors may acquire, from a third terminal of a third user among the remaining users, third payment information indicating a third payment amount corresponding to a portion of the remaining unpaid amount; request the payment server to process a third payment of the third payment amount based on the third payment information; and compare a sum amount of the second payment amount and the third payment amount to the remaining unpaid amount, according to a response from the payment server indicating that the third payment has been approved within a predetermined time interval from an approval time of the second payment.

In an embodiment, the one or more processors may deliver the first notification to the shop terminal and the terminals of the plurality of users when the sum amount matches the remaining unpaid amount.

In an embodiment, wherein, when the sum amount exceeds the remaining unpaid amount, the one or more processors are further configured to: deliver a request to cancel the third payment to the payment server; deliver a request to cancel the second payment and the third payment to the payment server; deliver a request to cancel a payment of a smaller payment amount selected from between the second payment and the third payment to the payment server; or deliver a request to cancel portions of the second payment and the third payment to the payment server according to a ratio of the remaining unpaid amount to the sum amount, based on a cancelation criterion predetermined by the first user.

In an embodiment, the one or more processors may acquire, from a third terminal of a third user among the remaining users, third payment information indicating a third payment amount corresponding to a portion of the remaining unpaid amount; request the payment server to process a third payment of the third payment amount based on the third payment information; acquire, from a fourth terminal of a fourth user among the remaining users, fourth payment information indicating a fourth payment amount corresponding to a portion of the remaining unpaid amount; request the payment server to process a fourth payment of the fourth payment amount based on the fourth payment information; compare a sum amount of the second payment amount, the third payment amount and the fourth payment amount to the remaining unpaid amount, according to a response from the payment server indicating that the third payment and the fourth payment have been approved within a predetermined time interval from an approval time of the second payment; determine whether the sum amount minus at least one amount selected from among the second payment amount, the third payment amount and the fourth payment amount matches the remaining unpaid amount, when the sum amount exceeds the remaining unpaid amount; and upon determining that the sum amount minus the selected amount matches the remaining unpaid amount, deliver, to the payment server, a request to cancel at least one payment corresponding to the selected amount.

In an embodiment, the one or more processors may acquire user information of the second user from the second terminal; acquire, from the payment server based on the user information, payment method information indicating information regarding a credit card of the second user; register the payment method information and the user information of the second user in the one or more memories; and request the payment server to process the second payment based on the payment method information and the second payment information acquired from the second terminal.

In an embodiment, the one or more processors may acquire, from the second terminal, payment method information indicating information regarding a credit card of the second user and the second payment information; and request the payment server to process the second payment based on the second payment information and the payment method information.

In one aspect of the present disclosure, a method for payment support may be proposed. The method according to an aspect of the present disclosure may be a method for supporting payments of a total amount to be paid which is spent in an offline shop by a plurality of users, and performed in a server including one or more processors and one or more memories storing commands that cause the one or more processors to perform an operation when the commands are executed by the one or more processors. The method according to an aspect of the present disclosure may include acquiring, from a first terminal of a first user among the plurality of users, sales information indicating the shop, an identifier for identifying a group of the plurality of users, and the total amount to be paid, invitation information for identifying the remaining users excluding the first user among the plurality of users, and first payment information indicating a first payment amount corresponding to a portion of the total amount to be paid; requesting a payment server to process a first payment of the first payment amount by the first user based on the first payment information; delivering the sales information and payment status information for the total amount to be paid to a shop terminal of the shop and terminals of the remaining users, and delivering the payment status information to the first terminal according to a response from the payment server indicating that the first payment has been approved, wherein the payment status information indicates a total paid amount or a total remaining unpaid amount out of the total amount to be paid; acquiring second payment information indicating a second payment amount corresponding to a portion of the remaining unpaid amount out of the total amount to be paid from a second terminal of a second user among the remaining users; requesting the payment server to process a second payment of the second payment amount by the second user based on the second payment information; updating and delivering the payment status information to the shop terminal and the terminals of the plurality of users according to a response from the payment server indicating that the second payment has been approved; delivering a first notification indicating that the payment of the total amount to be paid has been completed to the shop terminal and the terminals of the plurality of users when the payment of the total amount to be paid has been completed; acquiring a second notification indicating that a payment completion for the total amount to be paid is confirmed from the shop terminal; and delivering a third notification indicating that the payment completion for the total amount to be paid is confirmed to the terminals of the plurality of users upon a receipt of the second notification.

In an embodiment, the method according to the present disclosure may further include acquiring, from the shop terminal, designated-user information related to at least one of a payment number condition, a payment amount condition, and a payment frequency condition of a designated user; acquiring, from at least one of the first terminal, the second terminal and the invitation information, user identification information for at least one of the plurality of users; acquiring, from the one or more memories, payment history information for the shop of at least one of the plurality of users based on the user identification information; and determining the designated user corresponding to the shop among the plurality of users based on the payment history information and the designated-user information.

In an embodiment, the method according to the present disclosure may further include acquiring, from the shop terminal, information relating to a product of the shop that corresponds to the total amount to be paid; and delivering, to a terminal of the designated user, coupon information of the shop that relates to the product.

In an embodiment, the method according to the present disclosure may further include acquiring, from the shop terminal, information indicating a first application probability, a first discount rate, a second application probability higher than the first application probability, and a second discount rate higher than the first discount rate to apply a discount to a payment amount for the shop, wherein requesting the payment server to process the second payment comprises: in response to the acquisition of the second payment information, applying the first discount rate to the second payment amount according to the first application probability when the second user is not the designated user, and applying the second discount rate to the second payment amount according to the second application probability when the second user is the designated user; and requesting the payment server to process a payment of the second payment amount to which the first discount rate or the second discount rate is applied.

In an embodiment, the method according to the present disclosure may further include acquiring, from a third terminal of a third user among the remaining users, third payment information indicating a third payment amount corresponding to a portion of the remaining unpaid amount; requesting the payment server to process a third payment of the third payment amount based on the third payment information; and comparing a sum amount of the second payment amount and the third payment amount to the remaining unpaid amount, according to a response from the payment server indicating that the third payment has been approved within a predetermined time interval from an approval time of the second payment.

In an embodiment, wherein, when the sum amount exceeds the remaining unpaid amount, the method further includes: delivering a request to cancel the third payment to the payment server; delivering a request to cancel the second payment and the third payment to the payment server; delivering a request to cancel a payment of a smaller payment amount selected from between the second payment and the third payment to the payment server; or delivering a request to cancel portions of the second payment and the third payment to the payment server according to a ratio of the remaining unpaid amount to the sum amount, based on a cancelation criterion predetermined by the first user.

In an embodiment, wherein the method further includes: acquiring, from a third terminal of a third user among the remaining users, third payment information indicating a third payment amount corresponding to a portion of the remaining unpaid amount; requesting the payment server to process a third payment of the third payment amount based on the third payment information; acquiring, from a fourth terminal of a fourth user among the remaining users, fourth payment information indicating a fourth payment amount corresponding to a portion of the remaining unpaid amount; requesting the payment server to process a fourth payment of the fourth payment amount based on the fourth payment information; comparing a sum amount of the second payment amount, the third payment amount and the fourth payment amount to the remaining unpaid amount, according to a response from the payment server indicating that the third payment and the fourth payment have been approved within a predetermined time interval from an approval time of the second payment; determining whether the sum amount minus at least one amount selected from among the second payment amount, the third payment amount and the fourth payment amount matches the remaining unpaid amount, when the sum amount exceeds the remaining unpaid amount; and upon determining that the sum amount minus the selected amount matches the remaining unpaid amount, delivering, to the payment server, a request to cancel at least one payment corresponding to the selected amount.

In one aspect of the present disclosure, a non-transitory computer-readable recording medium storing commands for payment support may be proposed. The commands stored in the recording medium according to an aspect of the present disclosure may cause one or more processors to perform an operation when the commands are executed by the one or more processors in a server for supporting payments of a total amount to be paid which is spent in an offline shop by a plurality of users. The commands include acquiring, from a first terminal of a first user among the plurality of users, sales information indicating the shop, an identifier for identifying a group of the plurality of users, and the total amount to be paid, invitation information for identifying the remaining users excluding the first user among the plurality of users, and first payment information indicating a first payment amount corresponding to a portion of the total amount to be paid; requesting a payment server to process a first payment of the first payment amount by the first user based on the first payment information; delivering the sales information and payment status information for the total amount to be paid to a shop terminal of the shop and terminals of the remaining users, and delivering the payment status information to the first terminal according to a response from the payment server indicating that the first payment has been approved, wherein the payment status information indicates a total paid amount or a total remaining unpaid amount out of the total amount to be paid; acquiring second payment information indicating a second payment amount corresponding to a portion of the remaining unpaid amount out of the total amount to be paid from a second terminal of a second user among the remaining users; requesting the payment server to process a second payment of the second payment amount by the second user based on the second payment information; updating and delivering the payment status information to the shop terminal and the terminals of the plurality of users according to a response from the payment server indicating that the second payment has been approved; delivering a first notification indicating that the payment of the total amount to be paid is complete to the shop terminal and the terminals of the plurality of users when the payment of the total amount to be paid is complete; acquiring a second notification indicating that a payment completion for the total amount to be paid is confirmed from the shop terminal; and delivering a third notification indicating that the payment completion for the total amount to be paid is confirmed to the terminals of the plurality of users upon a receipt of the second notification.

### BRIEF DESCRIPTION OF DRAWINGS

The accompanying drawings, which are incorporated in and constitute a part of the specification, illustrate embodiments of the present disclosure.

FIG. 1 is a diagram showing a process in which a user terminal, a server, a payment server, and a shop terminal are operated in a situation where a person has a meal and pays for the meal according to an embodiment of the present disclosure.

FIG. 2 is a diagram showing a process in which a plurality of user terminals, a server, a payment server, and a shop terminal are operated in a situation where several people have a meal together and pay for the meal according to an embodiment of the present disclosure.

FIG. 3 is a diagram showing an operational process of a first terminal, a second terminal, a server, a payment server, and a shop terminal according to an embodiment of the present disclosure.

FIG. 4 is a block diagram of a server according to various embodiments of the present disclosure.

FIG. 5 is a diagram showing a process of designating a regular user for a shop from among a plurality of users according to an embodiment of the present disclosure.

FIG. 6 is a diagram showing a process of preferentially applying a discount application probability or a discount rate to a designated user of a shop according to an embodiment of the present disclosure.

FIG. 7 is a diagram showing a process of processing a plurality of payments approved within a predetermined time interval according to an embodiment of the present disclosure.

FIG. 8 is a diagram showing a process of processing a plurality of payments approved within a predetermined time interval according to an embodiment of the present disclosure.

FIG. 9 is a diagram showing a process of registering user information and payment method information according to an embodiment of the present disclosure.

FIG. 10 is a diagram showing screens displayed on a user's user terminal on a stage basis in a situation where a person has a meal and pays for the meal according to an embodiment of the present disclosure.

FIG. 11 is a diagram showing screens displayed on a first terminal of a first user on a stage basis in a situation where several people have a meal together and pay for the meal according to an embodiment of the present disclosure.

FIG. 12 is a diagram showing screens displayed on a second terminal of a second user on a stage basis in a situation where several people have a meal together and pay for the meal according to an embodiment of the present disclosure.

FIG. 13 is a diagram showing screens displayed on a shop terminal on a stage basis in a situation where several people have a meal together and pay for the meal according to an embodiment of the present disclosure.

FIG. 14 is a diagram showing an embodiment of a method for supporting payments that may be performed by a server according to the present disclosure.

### DETAILED DESCRIPTION

Various embodiments disclosed herein are illustrated for the purpose of clearly describing the technical spirit of the present disclosure and are not intended to limit the present disclosure to specific embodiments. The technical spirit of the present disclosure encompasses various modifications, equivalents, alternatives, and/or selective combinations of some or all of the embodiments disclosed herein. Also, the scope of the technical spirit of the present disclosure is not limited to the following various embodiments or the detailed description thereof.

The term used herein, including technical or scientific terms, have meanings that are generally understood by a person having ordinary knowledge in the art to which the present disclosure pertains, unless otherwise specified.

The expressions “include,” “may include,” “be provided with,” “may be provided with,” “have,” “may have,” and the like used herein indicate the existence of a corresponding feature (e.g., a function, an operation, or an element) and do not exclude the existence of an additional feature. That is, such expressions should be understood as open-ended terms connoting the possibility of inclusion of other embodiments.

A singular expression used herein can include meanings of plurality, unless otherwise mentioned, and the same is applied to a singular expression stated in the claims.

Unless otherwise mentioned, the terms “1st,” “2nd,” “first,” “second,” etc. used herein are used to differentiate a plurality of homogeneous components from one another and are not intended to limit the order or importance of the relevant components.

The expressions “A, B, and C,” “A, B, or C,” “A, B, and/or C,” “at least one of A, B, and C,” “at least one of A, B, or C,” “at least one of A, B, and/or C,” “at least one selected from among A, B, and C,” “at least one selected from among A, B, or C,” “at least one selected from among A, B, and/or C,” and the like used herein may denote the listed items or all possible combinations thereof. For example, the expression “at least one selected from A's and B's” may refer to all of (a) A's, (b) at least one of A's, (3) B's, (4) at least one of B's, (5) at least one of A's and at least one of B's, (6) B's and at least one of A's, (7) A's and at least one of B's, and (8) A's and B's.

The expression “based on” used herein is used to describe one or more factors that influence a decision, an action of judgment, or an operation described in a phrase or sentence including the relevant expression, and this expression does not exclude an additional factor influencing the decision, the action of judgment, or the operation.

When a certain component (e.g., a first component) is described as “coupled to” or “connected to” another component (e.g., a second component), this should be understood as having a meaning that the certain component may be coupled or connected directly to the another component or that the certain component may be coupled or connected to the another component via still another component.

The expression “configured to” used herein may have meanings such as “set to,” “having the capacity to,” “changed to,” “made to,” “capable of,” and the like according to the context. The expression “configured to” may not necessarily mean only “specifically designed to in hardware.” For example, a processor configured to perform a specific operation may mean a general-purpose processor capable of performing the specific operation by executing software.

Hereinafter, various embodiments of the present disclosure will be described with reference to the accompanying drawings. In the accompanying drawings and the description thereof, like reference numerals may be assigned to the same or substantially equivalent components. In the following description of the various embodiments, repeated descriptions of the identical or relevant components will be omitted. However, the components are not intended to be excluded in the corresponding embodiments.

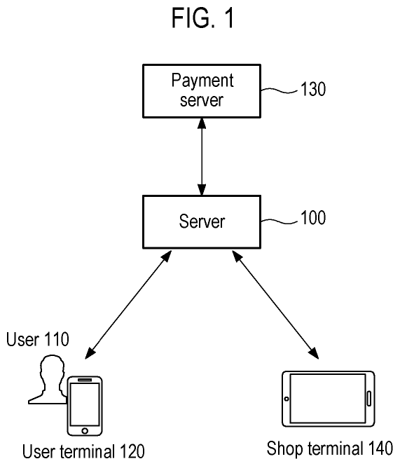

FIG. 1 is a diagram showing a process in which a user terminal 120, a server 100, a payment server 130, and a shop terminal 140 are operated in a situation where one person has a meal and pays for the meal according to an embodiment of the present disclosure. The user terminal 120, the server 100, the payment server 130, and the shop terminal 140 according to various embodiments of the present disclosure may perform operations for supporting a user's payment according to the present disclosure.

Specifically, an exemplary situation in which one person (hereinafter referred to as a user 110) who has a meal in a food service shop is assumed. The user 110 may pay at the table where he or she has the meal by means of the user terminal 120 before, while or after eating. In the present disclosure, the food service shop (or any suitable shop) may be an offline shop. In the present disclosure, a terminal used by the user, that is, the user terminal 120, may be one of various types of devices. For example, the user terminal 120 may be a portable communication device (e.g., a smartphone), a computer device (e.g., a tablet PC, a laptop, or the like), a portable multimedia device, a wearable device, or a device corresponding to one or more combinations of the aforementioned devices. A program (e.g., an application) for providing a payment support technology according to the present disclosure may be installed in the user terminal 120. Alternatively, the user terminal 120 may access a webpage for providing the payment support technology according to the present disclosure.

The user 110 may select one of a situation in which one person has a meal and pays for the meal alone and a situation in which several people have a meal and pay for the meal together, and may enter the selected situation into the user terminal 120. In this example, the user 110 may select the situation in which he or she pays alone.

Subsequently, the user 110 may enter information indicating the shop where he or she is having the meal (e.g., a shop name) into his or her user terminal 120. The information indicating the shop may be information for identifying the shop where the user 110 is having the meal. In an embodiment, the information indicating the shop may include the name, the identifier, the address, and the like of the corresponding shop. In an embodiment, the user terminal 120 may identify and display food service shops around the user terminal 120 using the Global Positioning System (GPS). The user 110 may view the displayed food service shops, and input information indicating the shop by selecting a shop where the user 110 is currently having a meal.

Also, the user 110 may enter, into his or her user terminal 120, information indicating an identifier for identifying the user 110 among people in the shop. The identifier for identifying the user 110 may be information indicating the number of the table where the user 110 is having the meal in the shop.

Also, the user 110 may enter, into his or her user terminal 120, information indicating a total amount to be paid which is spent in the shop. Since the user makes the payment alone, the total amount to be paid may be equal to the payment amount to be paid by the user 110.

The user terminal 120 may display the information entered by the user 110 (e.g., display the information on a display screen) to allow the user to confirm the entered information. When the user 110 confirms the displayed information, the user terminal 120 may authenticate the user 110 according to a predetermined method. In an embodiment, in order to authenticate the user 110, a process such as face recognition, iris recognition, fingerprint recognition, pattern input, and a password input may be performed in the user terminal 120. When the authentication is completed, the user terminal 120 may transmit the entered information to the server 100.

In the present disclosure, the server may provide the payment support technology according to the present disclosure. The server 100 may communicate with the user terminal 120 through the above-described program (e.g., application) installed in the user terminal 120. Also, the server 100 may provide the above-described webpage for providing the payment support technology according to the present disclosure. In an embodiment, the server 100 may be logically classified into a web server and a web application server (WAS). The web server may serve to process static content (e.g., an HTML page, etc.) in response to requests of the user terminal 120 and the shop terminal 140. The WAS may serve to communicate with the payment server 130 or access an internal database, process dynamic content requiring logical processing, and provide the processed dynamic content to the user terminal 120, the shop terminal 140, and the like through a web server.

The server 100 may request the payment server 130 to process a payment of the corresponding user 110 based on the information acquired from the user terminal 120. The payment request may be a payment request for a total amount to be paid entered by the user 110. In the present disclosure, the payment server 130 may include a payment gateway (PG) server and/or a simple payment server for processing a payment. In the present disclosure, the simple payment may refer to an electronic payment and settlement method for supporting simple payment capable of being made by a user using pre-registered payment information and the like. For example, according to the simple payment, a payment may be made using a pre-registered payment password (e.g., Personal Identification Number (PIN)), by performing authentication based on biometrical information such as a fingerprint, an iris, and a face by means of an electronic device such as a smartphone, or by recognizing payment information based on information such as a Quick Response (QR) code, a barcode, and the like by means of an electrode device such as a smartphone. The simple payment server may refer to a server or system for providing a simple payment. The payment server 130 may process the requested payment to approve or reject the corresponding payment.

According to a response indicating that the payment has been approved by the payment server 130, the server 100 may deliver a notification indicating that the payment of the total amount to be paid is complete (hereinafter referred to as a first notification) to the user terminal 120 and the shop terminal 140. In the present disclosure, the shop terminal 140 may be an electronic device provided in the shop in order to process a user's payment according to the payment support technique according to the present disclosure. The shop terminal 140 may be one of various forms of devices. For example, the shop terminal 140 may be a portable communication device (e.g., a smartphone), a computer device (e.g., a tablet PC, a laptop, a desktop, or the like), a portable multimedia device, a point of sale (POS) device, or a device corresponding to one or more combinations thereof. A program (e.g., an application) for providing the payment support technique according to the present disclosure may be installed in the shop terminal 140. Alternatively, the shop terminal 140 may access a webpage for providing the payment support technique according to the present disclosure. The shop terminal 140 may communicate with the server through the above-described program or webpage.

When the first notification is received, the user terminal 120 may display, to the user 110, a screen indicating that the payment of the total amount to be paid is complete and is currently being confirmed by a clerk of the shop, so that the user may wait. Also, when the first notification is received, the shop terminal 140 may display, to the clerk of the shop, a screen indicating that the payment by the user 110 is complete. The shop terminal 140 may also display the above-described identifier for identifying the user 110, for example, the table number, and may enable the user 110, for whom the payment is completed, to be identified. The clerk of the shop may confirm that the payment by the user 110 is completed by using the information shown by the shop terminal 140, and may enter, into the shop terminal 140, a signal indicating that the payment is confirmed. For example, the clerk of the shop may confirm that the payment is complete by pressing an “OK” button of the shop terminal 140. According to the input by the shop clerk, the shop terminal 140 may transmit, to the server 100, a notification indicating a confirmation that the payment of the amount to be paid is complete (hereinafter referred to as a second notification). When the second notification is received, the server 100 may transmit, to the user terminal 120, a notification indicating that the completion of the payment of the amount to be paid is confirmed by the shop (hereinafter referred to as a third notification). When the third notification is received, the user terminal 120 may display, to the user 110, a screen indicating that the payment confirmation of the shop is completed. The user 110 may confirm the corresponding screen displayed on his or her user terminal 120 and then leave the shop without waiting in line at the checkout counter of the shop or waiting for the clerk to process the payment at the table.

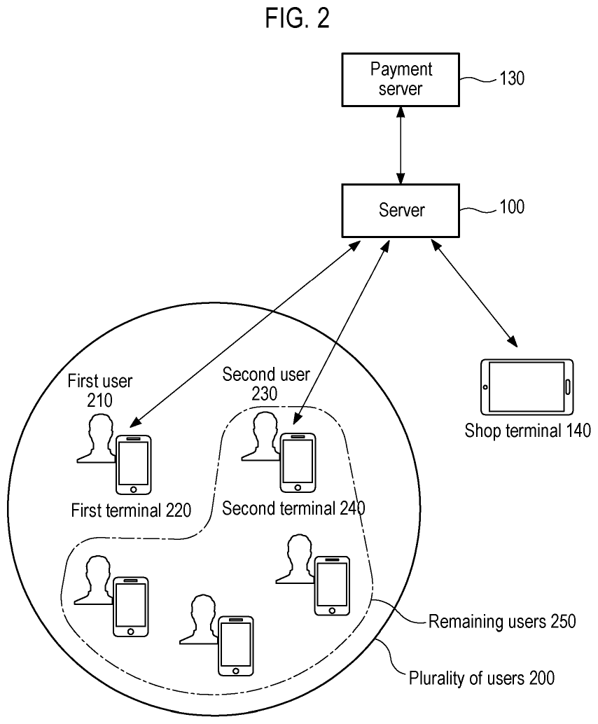

FIG. 2 is a diagram showing a process in which a plurality of user terminals 220, 240, and the like, a server 100, a payment server 130, and a shop terminal 140 are operated in a situation where several people have a meal together and pay for the meal according to an embodiment of the present disclosure. Specifically, an exemplary situation in which a group of people (hereinafter referred to as a plurality of users 200) have a meal in a food service shop is assumed. Similarly to the case in which only one user has a meal and pays for the meal alone, the plurality of users 200 may pay at the table where they have a meal by means of user terminals of the plurality of users 200 before, while or after having the meal. In order to pay according to the payment support technique according to the present disclosure, one of the plurality of users 200 (hereinafter referred to as a first user 210) may act as a so-called “cell leader” (see description below), and each of the remaining users 250 may act as a “participant” (see description below). Each of the users may have his or her user terminal.

The first user 210 may select one of a situation in which one person has a meal and pays for the meal alone and a situation in which several people have a meal and pay for the meal together, and may enter the selected situation into his or her user terminal (hereinafter referred to as a first terminal 220). In this example, the first user 210 may select the situation in which several people pay an amount to be paid through bill splitting.

Subsequently, the first user 210 may enter, into the first terminal 220, information indicating a shop where the plurality of users 200 are currently having a meal, information indicating an identifier for identifying the group of the plurality of users 200, and information indicating a total amount to be paid which is spent in the corresponding shop by the plurality of users 200. The information indicating the shop is the same as described above. The identifier for identifying the group of the plurality of users 200 may be the number of the table where the plurality of users 200 is having a meal in the shop. The information indicating the total amount to be paid may be information indicating the total amount to be paid which is spent in the corresponding shop by the plurality of users 200. In an embodiment, the information regarding the shop, the information for identifying the group of the plurality of users 200, and the information indicating the total amount to be paid may be collectively referred to as sales information.

Also, the first user 210 may enter invitation information to the first terminal 220. The invitation information may be user identification information for identifying the remaining users 250 excluding the first user 210 among the plurality of users 200. By entering the invitation information, the first user 210 may specify the remaining users 250 who will pay the total amount to be paid together with the first user 210. In an embodiment, the user identification information may be a name, phone number, ID, code assigned to the corresponding user, or the like. In an embodiment, the first user 210 may enter the invitation information for the remaining users 250 by selecting the remaining users 250 from among people recorded in an address book of the first terminal 220.

Also, the first user 210 may enter, into the first terminal 220, payment information (hereinafter referred to as first payment information) indicating a payment amount to be paid by the first user 210 (hereinafter referred to as a first payment amount). The first payment amount may correspond to a portion of the total amount to be paid.

The first terminal 220 may show the sales information, the invitation information, and/or the first payment information entered by the first user 210, and may enable the first user 210 to confirm the entered information. When the first user 210 confirms the displayed information, the first terminal 220 may authenticate the first user 210 according to a predetermined method. The authentication process is the same as described above.

When the authentication is completed, the first terminal 220 may transmit the sales information, the invitation information, and/or the first payment information. The server 100 may request the payment server 130 to process a payment of the first payment amount by the first user 210 (hereinafter referred to as a first payment) based on the first payment information. The payment server 130 may process the request for the first payment, and may transmit a response indicating the approval of the first payment or a response indicating the rejection of the first payment to the server 100 according to a result of the processing.

When the response indicating the approval of the first payment is received from the payment server 130, the server 100 may generate payment status information regarding the total amount to be paid. The server 100 may generate the payment status information based on the sales information, the invitation information, and/or the response received from the payment server 130. In an embodiment, the payment status information may indicate a total amount paid for which payment has been completed or a total remaining unpaid amount for which payment has not been completed out of the total amount to be paid. The total remaining unpaid amount may be equal to the total amount to be paid minus the total amount paid. In an embodiment, the payment status information may indicate an amount paid by each of the plurality of users 200 out of the total amount to be paid. In an embodiment, the payment status information may indicate a user who has not completed a payment among the plurality of users 200. For example, the payment status information generated by the server 100 in this stage may indicate that the first payment amount has been paid out of the total amount to be paid, and that the remaining unpaid amount (i.e., the total amount to be paid minus the first payment amount) has not been paid.

The server 100 may transmit the above-described shop information and/or payment status information to each of the terminals of the remaining users 250 and/or the shop terminal 140. Also, the server 100 may transmit the payment status information indicating the total amount to be paid to the first terminal 220. In an embodiment, when the response indicating the approval of the first payment is received from the payment server 130, the server 100 may transmit a notification indicating that the first payment is completed to the first terminal 220 along with the payment status information.

When the payment status information is received from the server 100, the first terminal 220 may display, to the first user 210, a current payment processing status for the total amount to be paid based on the payment status information. That is, the first terminal 220 may display, to the first user 210, information such as a total amount to be paid, a total amount paid so far (e.g., the first payment amount), the remaining unpaid amount which has not been paid yet, user identification information for identifying each of the plurality of users 200 and the number of users 200, user identification information for identifying each of the users who has completed his or her payment among the plurality of users 200 and the number of users who have completed their payments, and user identification information for identifying each of the users who has not completed his or her payment among the plurality of users 200 and the number of users who have not completed their payments.

When the sales information and the payment status information are received from the server 100, the shop terminal 140 may identify the group of the plurality of users 200 in the shop and determine that the received payment status information corresponds to the group of the plurality of users 200 based on the sales information. For example, the shop terminal 140 may recognize that the received payment status information indicates a payment status for a group of customers who sit at a table with a specific number allocated to the table. Also, the shop terminal 140 may show the current payment processing status for the total amount to be paid by the plurality of users 200 based on the payment status information. That is, the shop terminal 140 may show information for the group of the plurality of users 200 such as a total amount to be paid, a total amount paid so far (e.g., the first payment amount), the remaining unpaid amount that has not been paid yet, user identification information for identifying each of the plurality of users 200 and the number of users 200, user identification information for identifying each of the users who has completed his or her payment among the plurality of users 200 and the number of such users, and user identification information for identifying each of the users who has not completed his or her payment among the plurality of users 200 and the number of such users who have not completed their payments.

When the sales information and the payment status information are received from the server 100, one of the remaining users 250 (hereinafter referred to as a second user 230) may enter, into his or her terminal (hereinafter referred to as a second terminal 240), payment information (hereinafter second payment information) indicating a payment amount to be paid by the second user 230 (hereinafter referred to as second payment information). The second payment amount may correspond to a portion of the remaining unpaid amount out of the total amount to be paid. The second terminal 240 may display, to the second user 230, the corresponding shop, the information (e.g., a table number) for identifying the group of the plurality of users 200, and the total amount to be paid based on the sales information. Thus, the second terminal 240 may help the second user 230 to determine and input the second payment amount. Also, in an embodiment, the second terminal 240 may show the current payment processing status of the total amount to be paid based on the payment status information. In this case, information regarding the displayed payment processing status of the total amount to be paid may be the same as the information that is displayed on the above-described first terminal 220 based on the payment status information.

Like the request for the first payment and the transmission of the first payment information of the above-described first terminal 220, the second terminal 240 may display the information entered by the second user 230, perform an authentication process for the second user 230, and transmit the second payment information to the server 100. Also, the server 100 may request the payment server 130 to process a payment of the second payment amount by the second user 230 (hereinafter referred to as a second payment) based on the second payment information. When a response indicating the approval of the second payment is received from the payment server 130, the server 100 may update the payment status information. The updated payment status information may indicate that the payment of an amount equal to the sum of the first payment amount paid by the first user 210 and the second payment amount paid by the second user 230 is completed. The server 100 may transmit the updated payment status information to the shop terminal 140 and/or the terminals of the plurality of users 200. When the updated payment status information is received, the shop terminal 140 and the terminals of the plurality of users 200 may display the information regarding the current payment processing status for the total amount to be paid, as described above. In an embodiment, when the response indicating that the second payment has been approved is received from the payment server 130, the server 100 may transmit a notification indicating that the second payment is completed to the second terminal 240 along with the updated payment status information.

The remaining users 250 may designate and pay their payment amounts to be paid and may proceed with the payments in the same manner as the above-described second user 230. Through the payment by the remaining users 250, the payment of the total amount to be paid may be completed. In an embodiment, all of the remaining users 250 may complete the payment of the total amount to be paid by paying their payment amounts, or only some of the remaining users 250 may complete the payment of the total amount to be paid by paying their payment amounts.

When the payment of the total amount to be paid is completed, the server 100 may transmit a first notification, which indicates that the payment of the total amount to be paid is completed, to the shop terminal 140 and/or the terminals of the plurality of users 200. In an embodiment, the process in which the server 100 transmits the first notification may be omitted. In this case, each of the shop terminal 140 and the terminals of the plurality of users 200 may determine that the payment of the total amount to be paid is completed based on the payment status information delivered from the server 100 as the payment by the users is completed.

As described above, when the first notification is received, each of the terminals of the plurality of users 200 may display, to the corresponding one of the plurality of users 200, a screen indicating that the payment of the total amount to be paid is completed and also indicate that it is required to wait because the clerk of the shop is confirming the payment. Also, when the first notification is received, the shop terminal 140 may display, to the clerk of the shop, a screen indicating that the payment of the total amount to be paid by the group of the plurality of users 200 is completed. Along with the confirmation by the shop clerk, the shop terminal 140 may transmit, to the server 100, a second notification indicating the confirmation of the payment completion for the total amount to be paid. When the second notification is received, the server 100 may transmit, to the terminals of the plurality of users 200, a third notification indicating that the payment completion for the total amount to be paid is confirmed by the shop. When the third notification is received, the terminals of the plurality of users 200 display a screen indicating that the payment confirmation of the shop is completed, and the plurality or users 200 may confirm the screen and leave the shop.

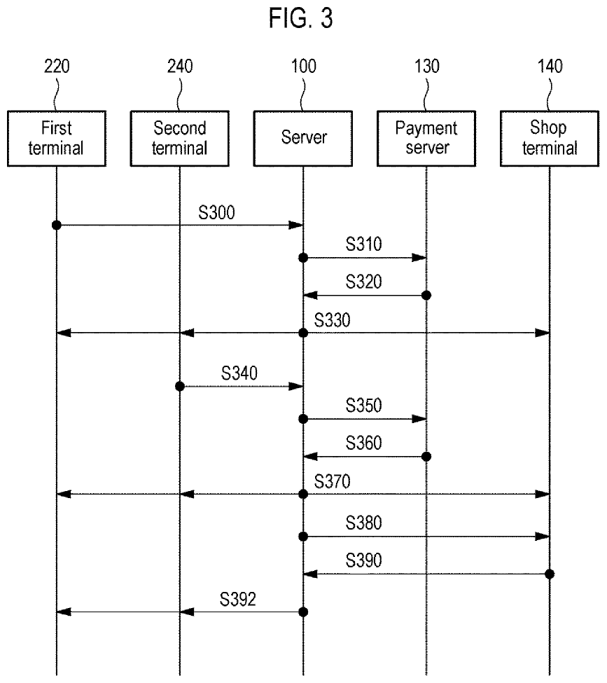

FIG. 3 is a diagram showing an operational process of the first terminal 220, the second terminal 240, the server 100, the payment server 130, and the shop terminal 140 according to an embodiment of the present disclosure. In a situation where several people have a meal together and pay for the meal, a plurality of user terminals may participate in the payment. However, for convenience of description, it is assumed that only the first terminal 220, which acts as a cell leader, and the second terminal 240, which acts as a participant, participate in the payment. In some embodiments, additional terminals acting as participants may participate in the payment. In this case, the additional terminals may operate similarly to the second terminal 240.

The first terminal 220 may transmit sales information, invitation information, and first payment information to the server 100. As described above, the sales information may include information indicating a corresponding shop, an identifier for identifying a group of a plurality of users 200, and a total amount to be paid. Also, the invitation information may include information for identifying the remaining users 250 to participate in the payment. The first payment information may indicate a first payment amount to be paid by a first user 210.

The server 100 may request the payment server 130 to process a first payment of the first payment amount by the first user 210 based on the first payment information (S310). The payment server 130 may transmit a response indicating that the first payment has been approved to the server 100 (S320).

According to the response indicating that the first payment has been approved, the server 100 may transmit the sales information and/or payment status information for the total amount to be paid to the shop terminal 140 and the terminals of the remaining users 250 (e.g., the second terminal 240) (S330). Also, according to the response indicating that the first payment has been approved, the server 100 may transmit the payment status information to the first terminal 220 (S330).

Upon receiving the sales information and/or the payment status information, the second terminal 240 may transmit second payment information to the server 100 (S340). The second payment information may indicate a second payment amount to be paid by a second user 230. The server 100 may request the payment server 130 to process a second payment of the second payment amount by the second user 230 based on the second payment information (S350). The payment server 130 may transmit a response indicating that the second payment has been approved to the server 100 (S360).

According to the response indicating that the second payment has been approved, the server 100 may update the payment status information, and transmit the updated payment status information to the shop terminal 140 and the terminals (e.g., the first terminal 220 and the second terminal 240) of the plurality of users 200 (S370).

When the payment of the total amount to be paid is completed, the server 100 may transmit a first notification to the shop terminal 140 and the terminals (e.g., the first terminal 220 and the second terminal 240) of the plurality of users 200 (S380). The first notification may indicate the completion of the payment of the total amount to be paid.

When a shop clerk confirms the completion of the payment, the shop terminal 140 may transmit a second notification to the server 100 (S390). The second notification may indicate the confirmation of the payment completion for the total amount to be paid. When the second notification is received, the server 100 may transmit a third notification to the terminals (e.g., the first terminal 220 and the second terminal 240) of the plurality of users 200 (S392). The third notification may indicate that the payment completion for the total amount to be paid is confirmed by the shop.

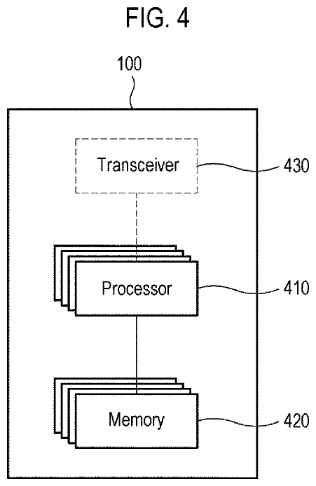

FIG. 4 is a block diagram of the server 100 according to various embodiments of the present disclosure. In an embodiment, the server 100 may include one or more processors 410 and/or one or more memories 420. In an embodiment, at least one of the components of the server 100 may be omitted, or another component may be added to the server 100. Additionally or alternatively, some of the components may be integrated with each other or may be implemented as a single entity or a plurality of entities. The components inside or outside the server 100 may be connected to each other through a bus, a general-purpose input/output (GPIO), a serial peripheral interface (SPI), a mobile industry processor interface (MIPI), or the like to transmit and receive data and/or signals.

The one or more processors 410 may execute software (e.g., a command, a program, etc.) to control at least one component of the server 100 connected to the one or more processors 410. Also, the one or more processors 410 may execute various operations associated with the present disclosure, such as operation, data generation, and processing. Also, the one or more processors 410 may load data or the like from the one or more memories 420 or may store the data or the like in the one or more memories 420. The one or more processors 410 may acquire sales information, invitation information, and/or first payment information from the first terminal 220, request the payment server 130 to process a first payment, and deliver sales information and/or payment status information to a user terminal and a shop terminal. Also, the one or more processors 410 may acquire second payment information from the second terminal 240, request the payment server 130 to process a second payment, update the payment status information, and deliver the updated payment status information to the user terminal and the shop terminal. Also, the one or more processors 410 may deliver the above-described first notification, acquire the second notification, and deliver a third notification.

The one or more memories 420 may store various types of data. The data stored in the memory 420 may be data acquired, processed, or used by at least one component of the server 100 and may include software (e.g., a command, a program, etc.). The memory 420 may include a volatile and/or nonvolatile memory. In the present disclosure, the command or program is software stored in the memory 420 and may include an operating system for controlling resources of the server 100, applications, and/or middleware for providing various functions to the applications so that the applications can utilize the server resources. The one or more memories 420 may store commands for instructing the one or more processors 410 to perform operations when the commands are executed by the one or more processors 410.

In an embodiment, the server 100 may further include a transceiver 430. The transceiver 430 may perform wireless or wired communication between the server 100 and the terminals of the users, between the server 100 and the payment server 130, and between the server 100 and the shop terminal 140. For example, the transceiver 430 may perform wireless communication according to a method including enhanced Mobile Broadband (eMBB), Ultra Reliable Low-Latency Communications (URLLC), Massive Machine Type Communications (MMTC), Long-Term Evolution (LTE), LTE Advance (LTE-A), Universal Mobile Telecommunications System (UMTS), Global System for Mobile Communications (GSM), code division multiple access (CDMA), wideband CDMA (WCDMA), Wireless Broadband (WiBro), Wi-Fi, Bluetooth, near field communication (NFC), Global Positioning System (GPS), global navigation satellite system (GNSS), or the like. For example, the transceiver 430 may perform wired communication according to a method including Universal Serial Bus (USB), high definition multimedia interface (HDMI), recommended standard 232 (RS-232), plain old telephone service (POTS), or the like. In an embodiment, the one or more processors 410 may control the transceiver 430 to perform communication with the terminals of the users, the payment server 130, and the shop terminal 140. Information acquired from the terminals of the users, the payment server 130, and the shop terminal 140 may be stored in the one or more memories 420.

The various embodiments of the server 100 according to the present disclosure may be provided in combination with one another. The embodiments may be combined to create alternative embodiments according to the number of cases, and the embodiments of the server 100 created through the combination may also fall within the scope of the present disclosure. Also, the above-described internal or external components of the server 100 according to the present disclosure may be added, changed, or removed depending on the embodiment. Also, the internal/external components of the above-described server 100 may be implemented as hardware components.

The user terminal (e.g., the first terminal 220, the second terminal 240, etc.) may include one or more processors and/or one or more memories. The one or more memories may store commands for instructing the one or more processors to perform operations when the commands are executed by the one or more processors. The one or more processors of the user terminal may perform operations corresponding to the above-described operation of the server 100 according to the payment support technique according to the present disclosure. In an embodiment, the user terminal may further include an input device and/or an output device. The input device is a device for receiving data from a user and may include, for example, a touch screen, a keyboard, a button, or the like. The output device is a device for visually providing various types of data processed by the user terminal to the user and may include, for example, a touch screen, a display screen, or the like.

The shop terminal 140 may include one or more processors and/or one or more memories. The one or more memories may store commands for instructing the one or more processors to perform operations when the commands are executed by the one or more processors. The one or more processors of the shop terminal 140 may perform operations corresponding to the above-described operation of the server 100 according to the payment support technique according to the present disclosure. In an embodiment, the shop terminal 140 may further include an input device and/or an output device. The input device and the output device are as described above.

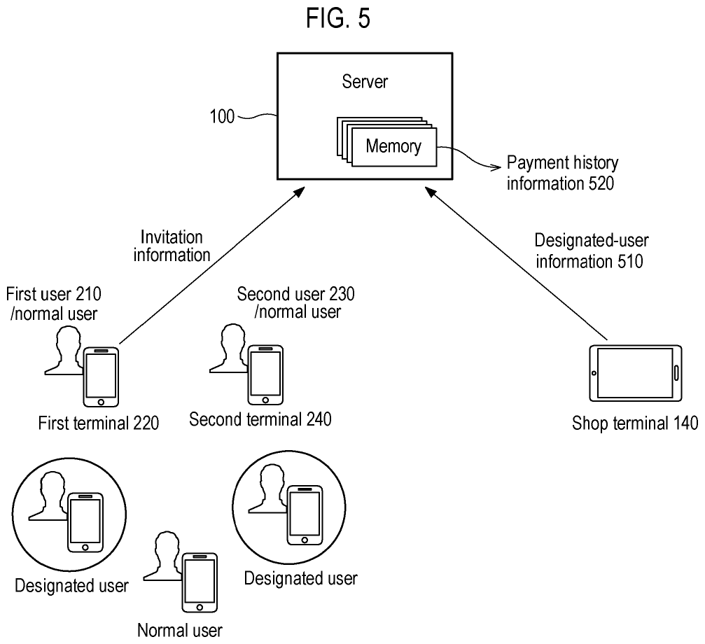

FIG. 5 is a diagram showing a process of designating a regular user for a shop from among the plurality of users 200 according to an embodiment of the present disclosure. In an embodiment, the server 100 may determine a regular user (hereinafter referred to as a designated user) from among the plurality of users 200 based on information predetermined by the shop.

In an embodiment, the shop may directly designate a user that is a designated user. Specifically, the owner or clerk of the shop may enter designated-user information 510 into the shop terminal 140. In this embodiment, the designated-user information 510 may include user identification information of a user to be designated as the designated user. The user to be designated as the designated user may be identified by the corresponding user identification information. The shop terminal 140 may transmit the designated-user information 510 to the server 100. Thus, the one or more processors 410 of the server 100 may acquire the designated-user information 510. In an embodiment, the one or more processors 410 may store the designated-user information 510 in the one or more memories 420. In an embodiment, the one or more memories 420 may serve as a database for storing the designated-user information 510.

Meanwhile, the one or more processors 410 may acquire user identification information for identifying at least one user of the plurality of users 200 from at least one of the first terminal 220, the second terminal 240 and the invitation information. In an embodiment, the one or more processors 410 may acquire user identification information of the first user 210, which is for identifying the first user 210, from the first terminal 220. Also, the one or more processors 410 may acquire user identification information of the remaining users 250, which is for identifying the remaining users 250, from the invitation information. That is, the one or more processors 410 may acquire user identification information for identifying the plurality of users 200 based on the first terminal 220 and the invitation information. In an embodiment, a participant who is participating in the payment (e.g., the second user 230) may be additionally included in the group of the plurality of users 200. In this case, the one or more processors 410 may acquire user identification information for identifying a corresponding additional participant (e.g., the second user 230) from the user terminal (e.g., the second terminal 240) of the corresponding additional participant (e.g., the second user 230).

The one or more processors 410 may determine at least one user from the group of the plurality of users 200 as a designated user of the corresponding shop based on the designated-user information 510 and the user identification information of at least one of the plurality of users 200. In an embodiment, the one or more processors 410 may compare the designated-user information 510 and the user identification information. When a piece of the user identification information matches the designated-user information 510, the one or more processors 410 may determine the user corresponding to the piece of the user identification information as the designated user of the shop.

In an embodiment, the shop may set a condition for becoming a designated user. Specifically, the owner or clerk of the shop may enter designated-user information 510 to the shop terminal 140. In this embodiment, the designated-user information 510 may include information indicating a condition for determining a user as a designated user. In this case, the designated-user information 510 may indicate a payment number condition, a payment amount condition, and/or a payment frequency condition which must be satisfied so as to designate the user as a designated user of the corresponding shop. The payment number condition may indicate the number of instances of payment in the corresponding shop which must be satisfied by the user to be a designated user. The payment amount condition may indicate the total amount of payment made so far in the shop which must be satisfied by the user to become a designated user. The payment frequency condition may indicate the frequency of payment in the corresponding shop, which must be satisfied by the user to be a designated user.

As described above, the shop terminal 140 may transmit the designated-user information 510 to the server 100. Thus, the one or more processors 410 of the server 100 may acquire the designated-user information 510 and store the acquired designated-user information 510 in the one or more memories 420. Also, as described above, the one or more processors 410 may acquire user identification information for identifying at least one of the plurality of users 200 from at least one of the first terminal 220, the second terminal 240 and the invitation information.

The one or more processors 410 may acquire payment history information 520 for the corresponding shop from the one or more memories 420 based on the acquired user identification information. The payment history information 520 may include information regarding the history of payments made in the corresponding shop through the server 100. The payment history information 520 may include user identification information for identifying users who have made payments in the shop, the number of times the corresponding users made payments, and information regarding a payment amount and/or a payment frequency for each payment. In an embodiment, the one or more memories 420 may serve as a database for storing the payment history information 520 of the corresponding shop. The one or more processors 410 may compare the acquired user identification information and the payment history information 520. When a payment history corresponding to the user identified by the acquired user identification information is present, the one or more processors 410 may acquire payment history information 520 associated with the user.

The one or more processors 410 may determine at least one user from the group of the plurality of users 200 as a designated user of the corresponding shop based on the acquired designated-user information 510 and payment history information 520. The one or more processors 410 may compare a user payment history of the acquired payment history information 520 to conditions indicated by the designated-user information 510. When the payment history of the corresponding user satisfies at least one of the conditions of the designated-user information 510, the one or more processors may determine the corresponding user as a designated user of the corresponding shop.

In an embodiment, the server 100 may acquire the designated-user information 510 by a route other than a route via the shop terminal 140. For example, the owner or clerk of the shop may enter the designated-user information 510 through a program for providing the payment support technique according to the present disclosure installed in the shop terminal 140, or may access a webpage for providing the payment support technique according to the present disclosure through the shop terminal 140 without having to install the program in the shop terminal 140. For example, the owner or clerk of the shop may communicate with the server 100 through a separate electronic device (e.g., a computer, a mobile communication terminal, etc.) to deliver the designated-user information 510 to the server 100.

In an embodiment, the payment history information 520 stored in the one or more memories 420 may include not only information indicating the history of payments made using the server 100, but also information indicating the history of payments made without using the server 100. In this case, the server 100 may communicate with the shop terminal 140 to acquire information indicating the history of payments made without using the server 100. The payments made without using the server 100 may include payments made by users in the corresponding shop without using the payment support technique according to the present disclosure but by means of a separate payment method (e.g., by cash, credit card, or the like).

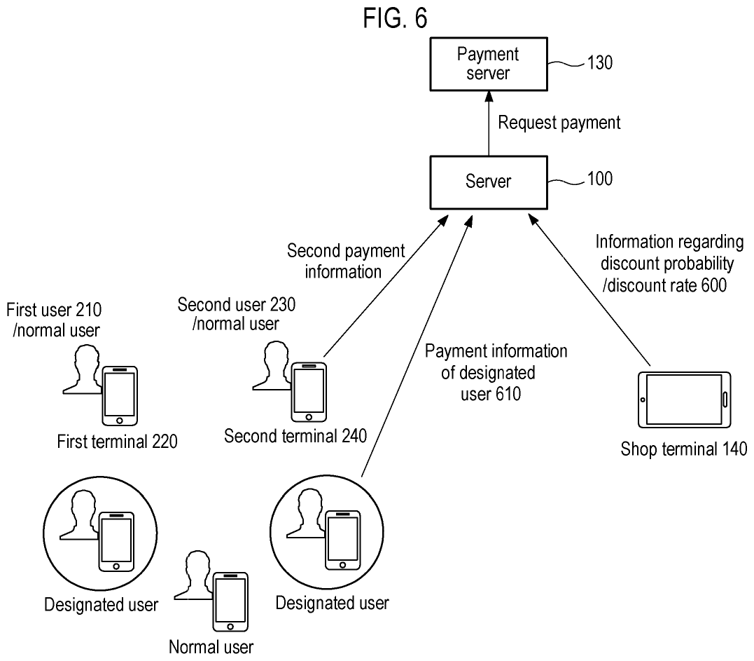

FIG. 6 is a diagram showing a process of preferentially applying a discount application probability or a discount rate to a designated user of a shop according to an embodiment of the present disclosure. In an embodiment, the server 100 may give benefits such as providing coupons, applying a preferential discount rate, and the like to a user determined as a designated user of the corresponding shop from among the plurality of users 200. The benefits may be predetermined by the shop.

In an embodiment, a coupon for the corresponding shop may be provided to the designated user. For example, the shop terminal 140 according to an embodiment may store information regarding products (e.g., food, beverage, etc.) ordered by the group of the plurality of users 200. The products may correspond to a total amount spent by the group of the plurality of users 200. The shop terminal 140 may transmit information indicating the above-described products to the server 100.

The one or more processors 410 of the server 100 may acquire the received information indicating the products. Meanwhile, the one or more memories 420 may store coupon information indicating predetermined products of the corresponding shop. The owner or clerk of the shop may predetermine the corresponding coupon information for the server 100 through the shop terminal 140 or another electronic device. The one or more processors 410 may compare the received product information to the coupon information stored in the one or more memories 420. When a piece of the coupon information corresponding to a product ordered by the group of the plurality of users 200 is present, the one or more processors 410 may deliver the corresponding coupon information to the terminal of the designated user. In an embodiment, the one or more processors 410 may deliver less beneficial coupon information to other users who are not a designated user (hereinafter referred to a normal user), and may deliver more beneficial coupon information to a designated user. In this case, the one or more memories may store information indicating coupons and also information indicating the degree of benefit of each coupon.

In an embodiment, a discount for each payment amount may be provided to the plurality of users 200 by drawing lots. In this case, a designated user may be set to win with a higher probability than that of a normal user, or a higher discount rate may be applied to a designated user than to a normal user when the designated user wins.

Specifically, the owner or clerk of the shop may enter, into the shop terminal 140, the probability of winning the lot for the discount (hereinafter referred to as a discount application probability) and/or a discount rate to be applied upon the winning (hereinafter referred to as a discount rate). In an embodiment, the probability of a normal user winning a lot (hereinafter referred to as a first application probability) and a discount rate to be applied to a payment amount of a normal user when the normal user wins (hereinafter referred to as a first discount rate) may be entered into the shop terminal 140. Also, in an embodiment, the probability of a designated user winning a lot (hereinafter referred to as a second application probability) and a discount rate to be applied to a payment amount of a designated user when the designated user wins (hereinafter referred to as a second discount rate) may be entered to the shop terminal 140. In an embodiment, the second application probability may be higher than the first application probability. In an embodiment, the second discount rate may be higher than the first discount rate.

The shop terminal 140 may transmit information 600 regarding the discount application probability and/or the discount rate to the server 100. The one or more processors 410 of the server 100 may acquire information indicating the first application probability, the first discount rate, the second application probability, and/or the first discount rate in order to apply a discount to a payment amount for the corresponding shop (e.g., a first payment amount, a second payment amount, etc.). In an embodiment, the one or more processors 410 may store the acquired information indicating the discount application probabilities and/or the discount rates in the one or more memories 420.

As described above, the one or more processors 410 may acquire payment information from a user terminal of one of the plurality of users 200. In response to the acquisition of the payment information, the one or more processors 410 may apply a discount rate to a payment amount corresponding to the payment information according to the discount application probability. When the corresponding user is not a designated user (that is, a normal user), the first discount rate may be applied to the corresponding payment amount with the first application probability. When the corresponding user is a designated user, the second discount rate may be applied to the corresponding payment amount with the second application probability.

For example, the above-described second user 230 may be classified as a normal user. In this case, the one or more processors 410 may acquire second payment information from the second terminal 240. In response to the acquisition of the second payment information, the one or more processors 410 may apply the first discount rate to the second payment amount according to the first application probability. That is, the one or more processors 410 may determine whether the second user 230 wins according to the first application probability and may apply the first discount rate to the second payment amount when the second user 230 wins. This example is for the purpose of explanation, and depending on the embodiment, the second user 230 may be determined as a designated user.

Further, for example, the one or more processors 410 may acquire payment information from a user terminal of one designated user 610. The acquired payment information may indicate a payment amount to be paid by the designated user 610. In response to the acquisition of the payment information, the one or more processors 410 may apply the second discount rate to the corresponding payment amount according to the second application probability. That is, the one or more processors 410 may determine whether the designated user 610 wins according to the second application probability and may apply the second discount rate to the payment amount when the designated user 610 wins.

When the application of the discount rate is completed according to the discount application probability, the one or more processors 410 may request the payment server 130 to process the payment of the discounted payment amount. That is, the one or more processors 410 may request the payment server 130 to process a payment of a payment amount discounted according to the first discount rate or the second discount rate. The one or more processors 410 may request the payment server 130 to process a payment of an undiscounted payment amount for a user who has not won.

In an embodiment, when the second application probability is set to be higher than the first application probability, the second discount rate may be set to be equal to the first discount rate. In an embodiment, when the second discount rate is set to be higher than the first discount rate, the second application probability may be set to be the same as the first application probability.

In an embodiment, the server 100 may apply the second application probability and the second discount rate to a payment amount of at least one user excluding the designated user based on user information of the plurality of users 200. For example, a normal user may be determined to be a senior in high school based on user information, and the current time may be determined to be less than one month after the end of this year's College Scholastic Ability Test based on information prestored in the server 100. In this case, the server 100 may apply the second application probability and the second discount rate to the payment amount of the corresponding user. In an embodiment, the server 100 may apply the first discount rate or the second discount rate to a payment amount of at least one user excluding the designated user based on the user information of the plurality of users 200 irrespective of the discount application probabilities. In an embodiment, the user information may be information registered in the server when the plurality of users 200 sign up for a program for providing the payment support technique according to the present disclosure or information acquired from a separate server by the server 100.

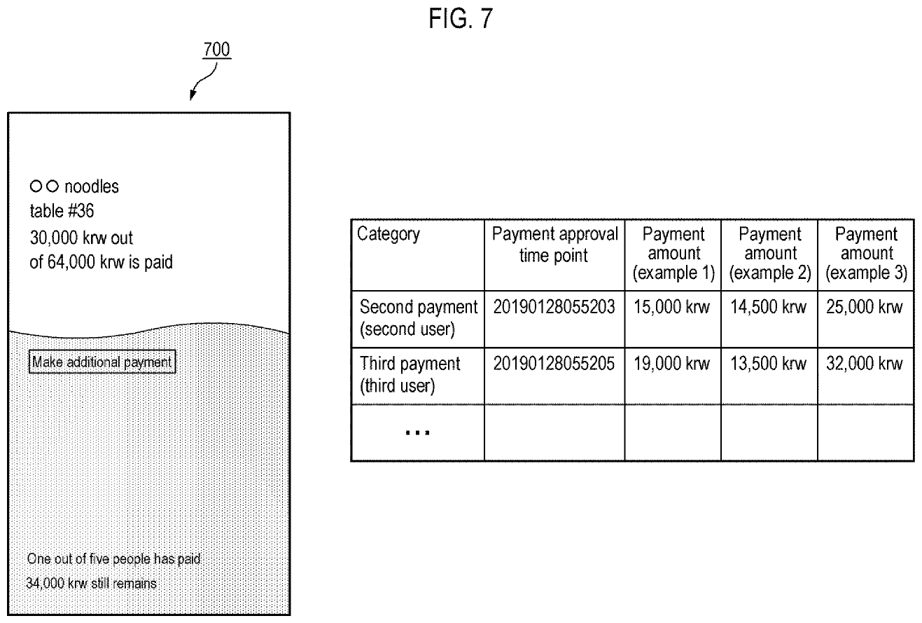

FIG. 7 is a diagram showing a process of processing a plurality of payments approved within a predetermined time interval according to an embodiment of the present disclosure. As described above, each of the remaining users 250 may pay his or her payment amount independently. Since a payment amount is arbitrarily determined by each of the remaining users 250, the sum of the payment amounts of which the payments have been approved may exceed the total amount to be paid or the total remaining unpaid amount. In an embodiment, in the process of receiving an amount to be paid from each of the remaining users 250, the terminal of each of the remaining users 250 may display the remaining unpaid amount out of the total amount to be paid based on the payment status information received from the server 100. However, even when a user sees the current remaining unpaid amount and then enters his or her payment amount, the user cannot know in real time how much payment amount the remaining users are entering. Also, it takes time for the payment amount of one user to be approved, reflected in the payment status information, and displayed in the remaining users' terminals. Accordingly, even when a user enters the payment amount while viewing the remaining unpaid amount, the sum of the approved payment amounts may exceed the total amount to be paid or the remaining unpaid amount.

In this case, the server 100 may process a payment corresponding to a portion exceeding the remaining unpaid amount according to various methods. In an embodiment, when a subsequent payment is approved after a long enough time (e.g., a predetermined time interval) after one payment is approved, the server 100 may cancel the subsequent payment. However, when a plurality of payments are consecutively approved within a short time interval (e.g., within a predetermined time interval), the server 100 may process the corresponding payments according to various criteria.

Specifically, apart from the approval of the second payment by the second user 230, the server 100 may process a payment (hereinafter referred to as a third payment) by another user (hereinafter referred to as a third user) among the remaining users 250. That is, the one or more processors 410 of the server 100 may acquire payment information (hereinafter referred to as third payment information) indicating a payment amount (hereinafter referred to as a third payment amount) to be paid by the third user from a terminal of the third user (hereinafter referred to as a third terminal). Like the above-described second payment amount which is a portion of the remaining unpaid amount out of the total amount to be paid, the third payment amount may be a portion of the corresponding remaining unpaid amount. The third payment amount may be equal to or different from the second payment amount. The one or more processors 410 may request the payment server 130 to process the third payment of the third payment amount based on the third payment information. The payment server 130 may process the third payment and may transmit, to the server 100, a response indicating that the third payment has been approved. According to the response indicating that the third payment has been approved, the one or more processors 410 of the server 100 may determine whether the approval time of the third payment is within a predetermined time interval from the approval time of the second payment that was made before. When the third payment is approved within a predetermined time interval from the approval time of the second payment, the one or more processors 410 may compare the sum of the payment amounts approved by the second payment and the third payment to the above-described remaining unpaid amount.

For example, as displayed on a screen 700 of the first terminal 220 of the first user 210, the total amount to be paid which is spent by the group of the plurality of users 200 may be 64,000 KRW. The first user 210, who is the current cell leader, may have already paid 30,000 KRW, and none of the remaining users 250 may have paid yet. In this case, the total paid amount is 30,000 KRW, and the total remaining unpaid amount is 34,000 KRW. In this case, the second payment for the second user may be approved. For example, as shown in Table 710 displaying various types of information related to the payment, the second payment may be approved at 05:52:03 on Jan. 28, 2019. Subsequently, within a predetermined time interval (e.g., five seconds), the third payment for the third user may be approved. For example, as shown in Table 710, the third payment may be approved at 05:52:05 on Jan. 28, 2019. The one or more processors 410 of the server 100 may be aware of a payment approval time and a payment amount for each payment based on information acquired from the user terminals and/or the payment server 130.

In an example (example 1), the second payment amount may be 15,000 KRW, and the third payment amount may be 19,000 KRW. In this case, when the sum of the payment amounts approved due to the second payment and third payment is equal to the above-described remaining unpaid amount, which is 34,000 KRW, both of the two payments may be maintained. When the sum amount is equal to the remaining unpaid amount, the one or more processors 410 may determine that the payment of the total amount to be paid (i.e., 64,000 KRW) is completed. Accordingly, as described above, the one or more processors 410 may deliver the first notification to the shop terminal 140 and the terminals of the plurality of users 200.

In an example (example 2), the second payment amount may be 14,500 KRW, and the third payment amount may be 13,500 KRW. In this case, when the sum amount of 28,000 KRW is less than the remaining unpaid amount of 34,000 KRW, both of the two payments may be maintained. In an embodiment, even though a payment is made once for each of the plurality of users 200, the payment of the total amount to be paid may not be complete. In this case, the one or more processors 410 may deliver, to the terminals of the plurality of users 200, a signal to display a screen to induce additional payment.

In an example (example 3), the second payment amount may be 25,000 KRW, and the third payment amount may be 32,000 KRW. In this case, when the sum amount of 57,000 KRW exceeds the remaining unpaid amount of 34,000 KRW, at least one of the two payments may need to be canceled. In an embodiment, the one or more processors 410 may cancel the payments based on a predetermined cancelation criterion. In an embodiment, the cancelation criterion may be predetermined by the first user who is the cell leader.

The cancelation criterion may be determined in various ways. In an embodiment, the one or more processors 410 may cancel payments in order of latest payment approval time first until the sum amount does not exceed the remaining unpaid amount. In this case, in example 3, the third payment may be canceled. The one or more processors 410 may deliver a request to cancel the third payment to the payment server 130.

In an embodiment, the one or more processors 410 may cancel all payments that exceed the remaining unpaid amount and that are made within the above-described predetermined time interval. In this case, in example 3, both the second payment and the third payment may be canceled. The one or more processors 410 may deliver a request to cancel the second payment and the third payment to the payment server 130.

In an embodiment, the one or more processors 410 may cancel payments in order of smallest payment amount first until the sum amount does not exceed the remaining unpaid amount. In this case, in example 3, the second payment may be canceled. The one or more processors 410 may deliver a request to cancel the second payment to the payment server 130.

In an embodiment, the one or more processors 410 may cancel a portion of each of the plurality of payments according to the ratio of the remaining unpaid amount to the sum amount. Since the remaining unpaid amount is 34,000 KRW and the sum amount is 57,000 KRW in example 3, the ratio of the remaining unpaid amount to the sum amount may be about 0.60 (=34000/57000). Accordingly, the one or more processors 410 may deliver a request to cancel a portion of an amount of 10,000 KRW, which corresponds to 40% of the payment amount for the second payment, to the payment server 130. Also, the one or more processors 410 may deliver a request to cancel a portion of an amount of 12,800 KRW, which corresponds to 40% of the payment amount for the third payment, to the payment server 130.

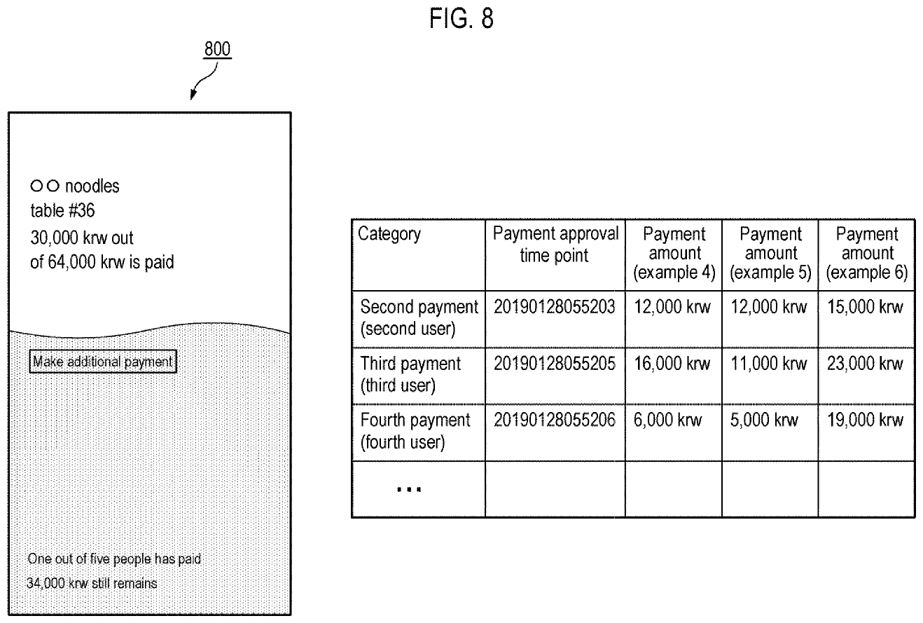

FIG. 8 is a diagram showing a process of processing a plurality of payments approved within a predetermined time interval according to an embodiment of the present disclosure. In this process, it is assumed that three payments are approved within the predetermined time interval and the amount of the payments exceeds the remaining unpaid amount. As described above, apart from the approval of the second payment by the second user and the third payment by the third user, the server 100 may process a payment (hereinafter referred to as a fourth payment) by another user (hereinafter referred to as a fourth user) among the remaining users 250. That is, the one or more processors 410 of the server 100 may acquire payment information (hereinafter referred to as fourth payment information) indicating a payment amount (hereinafter referred to as a fourth payment amount) to be paid by the fourth user from a terminal of the fourth user (hereinafter referred to as a fourth terminal). Like the above-described second payment amount and third payment amount being portions of the remaining unpaid amount out of the total amount to be paid, the fourth payment amount may be a portion of the corresponding remaining unpaid amount. The one or more processors 410 may request the payment server 130 to process the fourth payment of the fourth payment amount based on the fourth payment information. The payment server 130 may process the fourth payment and may transmit, to the server 100, a response indicating that the fourth payment has been approved. According to the response indicating that the fourth payment has been approved, the one or more processors 410 may determine whether the third payment and the fourth payment are approved within the predetermined time interval from the approval time of the second payment that was made before. When the third payment and the fourth payment are approved within the predetermined time interval from the approval time of the second payment, the one or more processors 410 may compare the sum of the payment amounts approved by the second payment, the third payment and the fourth payment to the above-described remaining unpaid amount.

For example (800), as described above, the total amount to be paid may be 64,000 KRW, the total paid amount may be 30,000 KRW, and the total remaining unpaid amount may be 34,000 KRW. Only the first user among the plurality of users 200 may have made a payment. In this case, the second payment may be approved at 05:52:03 on Jan. 28, 2019. The third payment may be approved at 05:52:05 on Jan. 28, 2019. The fourth payment may be approved at 05:52:06 on Jan. 28, 2019. The third payment and the fourth payment may be approved within a predetermined time interval (e.g., five seconds) from the approval time of the second payment.

In an example (example 4), the second payment amount, the third payment amount, and the fourth payment amount may be 12,000 KRW, 16,000 KRW, and 6,000 KRW, respectively. In this case, the sum of the amounts paid through the second payment, the third payment and the fourth payment is equal to the remaining unpaid amount of 34,000 KRW. Accordingly, as described above, the one or more processors 410 may deliver the first notification to the shop terminal 140 and the terminals of the plurality of users 200.

In an example (example 5), the second payment amount, the third payment amount and the fourth payment amount may be 12,000 KRW, 11,000 KRW, and 5,000 KRW, respectively. Since the sum amount is less than the remaining unpaid amount of 34,000 KRW, all three payments may be maintained.

In an example (example 6), the second payment amount, the third payment amount and the fourth payment amount may be 15,000 KRW, 23,000 KRW, and 19,000 KRW, respectively. The sum amount is 57,000 KRW, which exceeds the remaining unpaid amount of 34,000 KRW. In this case, as described above, the one or more processors 410 may cancel the payments based on the above-described cancelation criterion. For example, a cancelation criterion in which payments are canceled in order from the latest payment approval time may be followed until the sum amount does not exceed the remaining unpaid amount. In this case, the one or more processors 410 may deliver a request to cancel the fourth payment to the payment server 130 and then may deliver a request to cancel the third payment to the payment server 130.

For example, as described above, when a cancelation criterion according to which all payments within a predetermined time interval are canceled is followed, the one or more processors 410 may deliver a request to cancel all of the three payments to the payment server 130.

For example, as described above, a cancelation criterion in which payments are canceled in the order from the smallest payment amount may be followed until the sum amount does not exceed the remaining unpaid amount. In this case, the one or more processors 410 may deliver a request to cancel the second payment to the payment server 130 and then may deliver a request to cancel the fourth payment to the payment server 130.

For example, as described above, a cancelation criterion in which a portion of each of the plurality of payments is canceled may be followed according to the ratio of the remaining unpaid amount to the sum amount. The ratio of the remaining unpaid amount to the sum amount is about 0.60 (=34000/57000). Accordingly, the one or more processors 410 may deliver a request to cancel a portion of an amount of 6,000 KRW, which corresponds to 40% of the payment amount for the second payment, to the payment server 130. Also, the one or more processors 410 may deliver a request to cancel a portion of an amount of 9,200 KRW, which corresponds to 40% of the payment amount for the third payment, to the payment server 130. Also, the one or more processors 410 may deliver a request to cancel a portion of an amount of 7,600 KRW, which corresponds to 40% of the payment amount for the fourth payment, to the payment server 130.

In an embodiment, when the remaining unpaid amount is exceeded and if a combination obtained by adding up payment amounts for a plurality of payments approved within a predetermined time interval according to the number of cases matches the corresponding remaining unpaid amount, the payment corresponding to the combination may be maintained, and all of the remaining payments may be canceled. That is, the one or more processors 410 may determine whether the sum amount obtained by adding up the plurality of payment amounts minus at least one selected from among the plurality of payment amounts matches the corresponding remaining unpaid amount. According to a determination that the amounts match each other, the one or more processors 410 may deliver a request to cancel at least one payment corresponding to the selected payment amount to the payment server 130. In example 6, the sum amount obtained by adding the second payment amount of 15,000 KRW and the fourth payment amount of 19,000 KRW is 34,000 KRW and thus matches the remaining unpaid amount of 34,000 KRW. In this case, the approval time of the third payment is earlier than that of the fourth payment, and the third payment amount is the largest. However, the third payment may be canceled, and the second payment and the fourth payment may be maintained. The one or more processors 410 may deliver a request to cancel the third payment to the payment server 130.

In an embodiment, a payment to be canceled may be determined not based on the payment approval time but based on a time at which payment information is delivered from a user terminal to the server 100, that is, a time at which a payment is requested from the server 100.

In an embodiment, the payment of the total amount to be paid may be completed only by the payments of some of the plurality of users 200. For example, the payment of the total amount to be paid may be completed only by the payments of the second user and the third user, and the remaining users may not make payments.

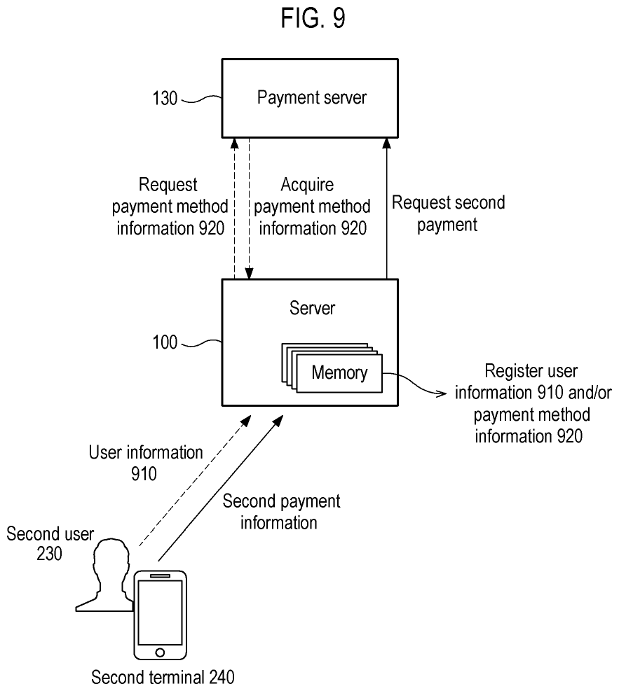

FIG. 9 is a diagram showing a process of registering user information and payment method information according to an embodiment of the present disclosure. A user (e.g., the second user 230) of a terminal (e.g., the second terminal 240), in which a program (e.g., an application) for providing a payment support technique according to the present disclosure is installed, may sign up for the corresponding program in advance. During the signing-up process, the server 100 may automatically acquire payment method information of the corresponding user (e.g., the second user 230) and may store the acquired payment method information in the one or more memories 420. The process of registering the user information and the payment method information with respect to the second user 230 will be described below but is not limited to the second user 230.

Specifically, the second user 230 may enter user information 910 of the second user 230 into the second terminal 240 in order to register. The user information 910 may include various types of information such as personal information of the second user 230, terminal information of the second terminal 240, and the like. The second terminal 240 may transmit the user information 910 of the second user 230 to the server 100.

The one or more processors 410 of the server 100 may acquire the user information 910. The one or more processors 410 may request the payment server 130 to transmit payment method information 920 indicating information regarding a payment method of the second user 230 based on the user information 910.

The payment server 130 may check whether the second user 230 has a payment method pre-registered in the payment server 130 for the purpose of simple payment based on the user information 910. When the second user 230 has pre-registered a payment method, the payment server 130 may transmit the payment method information 920 of the payment method to the server 100. For example, when the second user 230 has pre-registered his or her credit card in the payment server 130 for the purpose of simple payment, information regarding the credit card (i.e., the payment method information 920) may be delivered to the server 100. Thus, the second user 230 may enter only his or her user information 910 when registering for membership and may not separately enter the payment method information 920. In this case, subsequent payments may be easily processed by the payment method information 920 that is automatically acquired from the payment server 130. In an embodiment, the payment method may be the corresponding user's credit card or another payment method such as the corresponding user's debit card.

The one or more processors 410 may register (i.e., store) the acquired user information 910 and/or payment method information 920 of the second user 230 in the one or more memories 420. In an embodiment, the one or more memories 420 may serve as a database for storing payment method information and/or user information of users. By registering the user information 910 and/or the payment method information 920, the registration of the second user 230 may be completed.

When the above-described registration process is completed and the second payment information is received from the second terminal 240 as described above, the one or more processors 410 may process the second payment based on the pre-registered payment method information 920. That is, the one or more processors 410 may request the payment server 130 to process the second payment based on the pre-registered payment method information 920 and the second payment information acquired from the second terminal 240.

In an embodiment, the program (e.g., the application) for providing the payment support technique according to the present disclosure may not be installed in the second terminal 240 until the second payment is made. Also, the second user 230 may not register for the corresponding program until the second payment is made. That is, the second terminal 240 may proceed with the second payment through the above-described webpage that provides the payment support technique according to the present disclosure. In this case, the second user 230 may enter the second payment amount and the like into the second terminal 240 and may also enter the payment method information 920 for his or her payment method. The second terminal 240 may transmit the second payment information and the payment method information 920 to the server 100. The one or more processors 410 of the server 100 may acquire the second payment information and the payment method information 920, and may request the payment server 130 to process the second payment based on the acquired second payment information and payment method information 920.

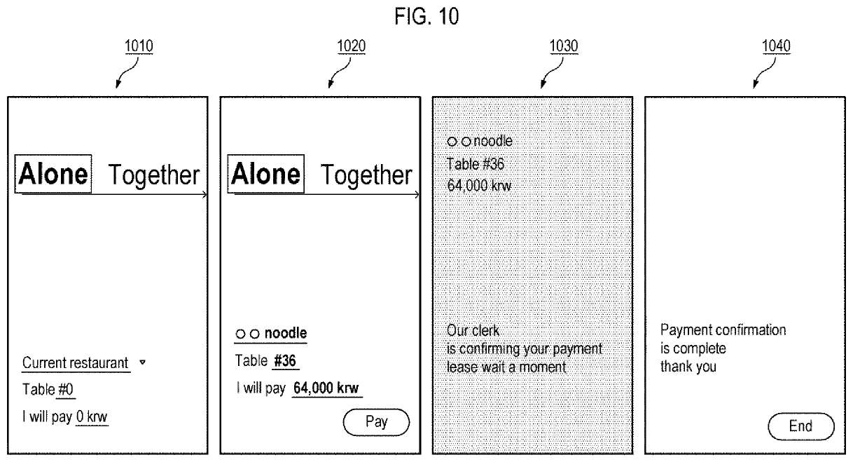

FIG. 10 is a diagram showing screens displayed on a user terminal 120 of a user 110 in each stage in a situation where a person has a meal and pays for the meal according to an embodiment of the present disclosure. The user terminal 120 of the user 110 who pays alone may show a screen for receiving an input of the user 110 (1010). In the corresponding screen 1010, the user 110 may select whether one person has a meal and pays alone or whether several people have a meal and pay together, and enter the selection. For example, when the user 110 selects “alone” in the corresponding screen 1010, a current situation in which one person has a meal and pays alone may be input to the user terminal 120. Also, as described above, the user 110 may enter, into the corresponding screen 1010, information regarding the corresponding shop, an identifier (e.g., a table number) for identifying the user 110 among people in the corresponding shop, and/or a total amount to be paid that is spent in the corresponding shop by the user 110. For example, when the user 110 selects a “current restaurant” part, food service shops located near the user terminal 120 may be listed. The user 110 may select a shop where he or she is having a meal from the listed shops and may enter information regarding the shop to the user terminal 120. Also, the user 110 may select parts “#0” and “0 krw” to enter the table number and the total amount to be paid.

In an embodiment, by the user 110 scanning a barcode, a QR code, or an NFC code attached to a corresponding table using the user terminal 120, the table number may be entered into the user terminal 120.

In an embodiment, when the clerk of the shop provides a bill, the user 110 may scan a barcode, a QR code, or an NFC code attached to the corresponding bill using the user terminal 120, and thus the shop name, the table number, and the total amount to be paid may be entered into the user terminal 120.

When the above-described input process is completed, the user terminal 120 may show a screen 1020 to allow the user 110 to confirm the entered information. For example, the corresponding screen 1020 may display that a user desires to pay 64,000 KRW at table #36 at OO Noodles. The user 110 may check the displayed information, press a “pay” button, and proceed with a subsequent payment process. Subsequently, as described above, the user terminal 120 may transmit the entered information to the server 100 to proceed with the payment.

When the payment of the total amount to be paid is complete, the user terminal 120 may display a guide screen 1030 to wait because a shop clerk is confirming the payment. The corresponding screen 1030 may also show the corresponding shop name, the table number, the total amount to be paid, and the like. The corresponding screen 1030 may be maintained until the shop clerk confirms the payment confirmation through the shop terminal 140 and the third notification is received from the server 100 to the user terminal 120 as described above.

When the third notification is received from the server 100, the user terminal 120 may display a guide screen 1040 indicating that the payment confirmation of the shop is completed. In an embodiment, the user 110 may press an “end” button in the corresponding screen 1040 and terminate the entire payment process.

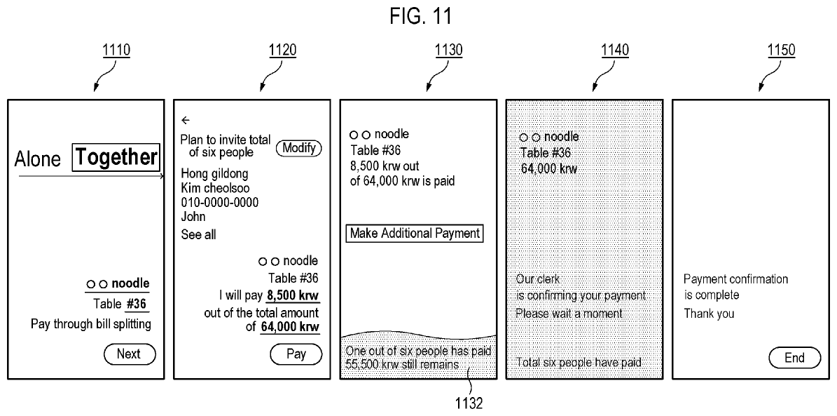

FIG. 11 is a diagram showing screens displayed on the first terminal 220 of the first user 210 on a stage basis in a situation where several people have a meal together and pay for the meal according to an embodiment of the present disclosure. Like the above-described case in which a payment is made alone, the first terminal 220 of the first user 210, which acts as a cell leader, may display a screen (not shown) for receiving an input of the first user 210. The first user 210 may select “together” in the corresponding screen to enter, into the first terminal 220, a situation in which several people have a meal and pay together. Also, through the corresponding screen, the first user 210 may enter information regarding the corresponding shop and an identifier (e.g., a table number) for identifying the group of the plurality of users 200 in the corresponding shop. The method of inputting the corresponding information may be the same as the above-described case of paying alone. When the input is completed, the first terminal 220 may display a screen 1110 to allow the first user 210 to confirm the information entered by the first user 210.

When the first user 210 presses a “next” button of the screen 1110 to confirm the entered information, the first terminal 220 may display a screen 1120 for inviting the remaining users 250 and entering the total amount to be paid and the first payment amount. Through the corresponding screen 1120, as described above, the first user 210 may enter the invitation information for inviting the remaining users 250 (e.g., six users). For example, the first user 210 may enter the invitation information by selecting Hong Gildong, Kim Cheolsoo, John, etc., from among the people contained in an address book stored in the first terminal 220. Also, for example, for people who are not stored in the address book, the first user 210 may enter invitation information for a corresponding user by directly entering a phone number of the corresponding user such as, for example, 010-0000-0000. In addition, through the corresponding screen 1120, the first user 210 may enter the total amount to be paid (e.g., 64,000 KRW) and the first payment amount to be paid by the first user 210 (e.g., 8,500 KRW). The first user 210 may confirm the displayed information, press a “pay” button, and proceed with a subsequent payment process. Subsequently, as described above, the first terminal 220 may transmit the entered sales information, invitation information, and the first payment information to the server 100 to proceed with the first payment.

When the first payment is completed, the first terminal 220 may display, to the user 210, a screen 1130 indicating the current payment processing status for the total amount to be paid. The corresponding screen 1130 may be generated based on the above-described payment status information. The corresponding screen 1130 may display a corresponding shop name (e.g., OO Noodles), a table number (e.g., #36), a total amount to be paid (e.g., 64,000 KRW), and a total paid amount that has been paid so far (e.g., 8,500 KRW). Also, the corresponding screen 1130 may display the number of plurality of users 200 (e.g., six users) and the number of users who have completed a payment (e.g., one user). Also, the corresponding screen 1130 may show the total remaining unpaid amount (e.g., 55,500 KRW). In an embodiment, the first user 210 may press a “make additional payment” button to additionally pay a predetermined amount out of the remaining unpaid amount.

In an embodiment, the first terminal 220 may visually display a ratio of the total paid amount, which has been paid so far, to the total amount to be paid. In an embodiment, the first terminal 220 may perform coloring or shading on some regions 1132 of the entire screen according to the ratio of the total paid amount to the total amount to be paid. For example, the total paid amount of 8,500 KRW corresponds to about 13% of the total amount to be paid of 64,000 KRW. Thus, the first terminal 220 may display a region 1132 corresponding to about 13% of the entire screen in a specific color or shade. Whenever the remaining users 250 make payments to increase the total paid amount, the percentage of the area occupied by the corresponding region 1132 may increase by reflecting the updated total paid amount. The corresponding region 1132 may not be stationary but may act like a fluid while maintaining the ratio of the area to the entire screen. For example, when the posture of the first terminal 220 changes in the yaw direction, the pitch direction, or the roll direction in a three-dimensional (3D) space, a gyro sensor of the first terminal 220 may sense the change in posture. Based on the sensing result of the gyro sensor, the corresponding region 1132 may move in the corresponding screen 1130 in the direction of gravity.

When the payment of the total amount to be paid is completed, the first terminal 220 may display a guide screen 1140 to wait because a shop clerk is confirming the payment. As described above, when the third notification is received from the server 100, the first terminal 220 may display a guide screen 1150 indicating that the payment confirmation of the shop is completed. The screen 1140 and the screen 1150 may be the same as the screens 1130 and 1140, respectively, corresponding to the situation where one person pays alone.

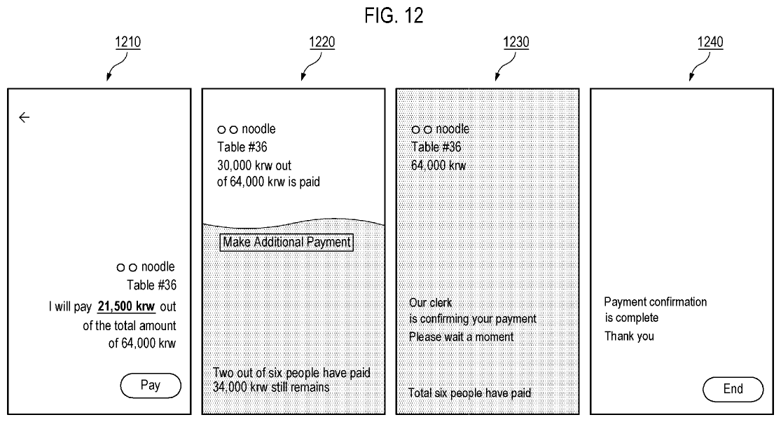

FIG. 12 is a diagram showing screens displayed on the second terminal 240 of the second user 230 on a stage basis in a situation where several people have a meal and pay for the meal according to an embodiment of the present disclosure. As described above, when the sales information and the payment status information are received from the server 100, the second terminal 240 may display the sales information and may also display a screen 1210 for receiving the second payment amount. The corresponding screen 1210 may display a corresponding shop name (e.g., OO Noodles), a table number (e.g., #36), and/or a total amount to be paid (e.g., 64,000 KRW). Through the corresponding screen 1210, the second user 230 may enter the second payment amount (e.g., 21,500 KRW) to be paid by the second user 230. In an embodiment, through the corresponding screen 1210, information indicating the current payment processing status for the total amount to be paid may be displayed along with other information.

When the second payment is completed, the second terminal 240 may display, to the second user 230, a screen 1220 indicating the current payment processing status for the total amount to be paid. The corresponding screen 1220 may be displayed in the same manner as that of the screen 1130 corresponding to the situation where one person pays alone. In the corresponding screen 1220, however, the sum (e.g., 30,000 KRW) of the first payment amount and the second payment amount may be shown as the total paid amount that has been paid so far, and two people corresponding to the first user 210 and the second user 230 may be shown as the number of people who have completed their payments. Also, since the total paid amount has increased, the percentage of the area of a region marked with a specific color or shade may increase to about 46% of the entire screen.

When the payment of the total amount to be paid is completed, the second terminal 240 may show a guide screen 1230 to wait because a shop clerk is confirming the payment. As described above, when the third notification is received from the server 100, the second terminal 240 may display a guide screen 1240 indicating that the payment confirmation of the shop is completed. The screen 1230 and the screen 1240 may be the same as the corresponding screens 1140 and 1150, respectively, of the above-described first terminal 220.

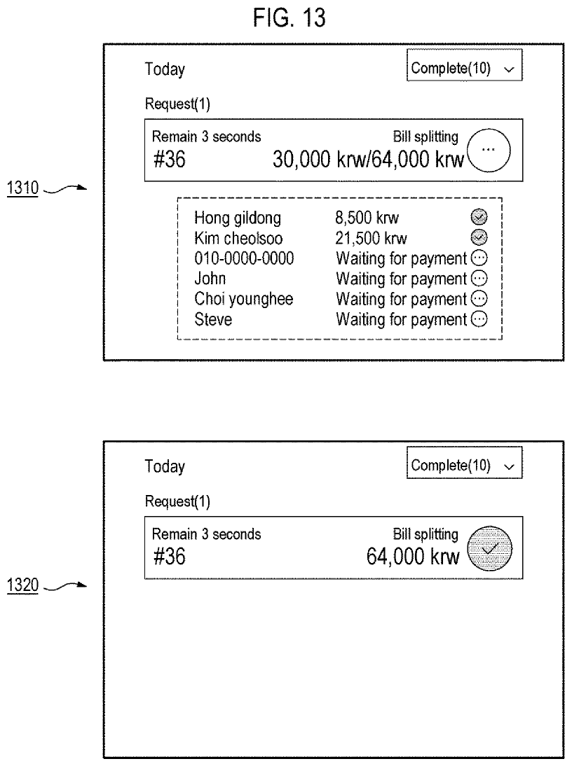

FIG. 13 is a diagram showing screens displayed on the shop terminal 140 on a stage basis in a situation where several people have a meal and pay for the meal together according to an embodiment of the present disclosure. When payment of only a portion of the total amount to be paid is completed, the shop terminal 140 may display a screen 1310 indicating the current payment processing status for the total amount to be paid. As described above, when the payment status information is received from the server 100, the shop terminal 140 may display the current payment processing status based on the payment status information. For example, the corresponding screen 1310 may display that the first user (e.g., Hong Gildong) has paid 8,500 KRW, the second user (e.g., Kim Cheolsoo) has paid 21,500 KRW, and the remaining users (e.g., 010-0000-0000, John, Choi Younghee, and Steve) have not yet completed payments. Also, the corresponding screen 1310 may display that 30,000 KRW out of the total amount to be paid of 64,000 KRW has been paid.

When the payment of the total amount to be paid is completed, the shop terminal 140 may display a screen 1320 indicating that the payment of the total amount to be paid has been completed. The corresponding screen 1320 may display the total amount to be paid (e.g., 64,000 KRW), the table number, and the like. Through the corresponding screen 1320, a shop clerk may enter, into the shop terminal 140, information indicating that the completion of the payment for the group of the plurality of users 200 is confirmed. Subsequently, as described above, the shop terminal 140 may transmit the second notification to the server 100.

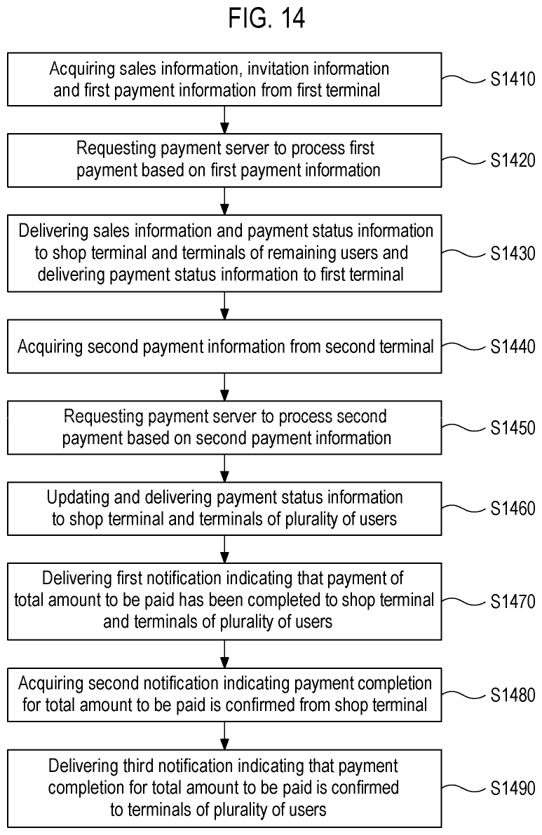

FIG. 14 is a diagram showing an embodiment of a method for supporting payments that may be performed by the server 100 according to the present disclosure. The payment support method according to the present disclosure may be a computer-implemented method. Although the operations of the method or algorithm according to the present disclosure have been described in a sequential order in the illustrated flowchart, the operations may be performed in any order that may be arbitrarily combined by the present disclosure as well as in the sequential order. The description according to the flowchart does not exclude making changes or modifications to the method or algorithm and does not mean that any operation is necessary or desirable. In an embodiment, at least one operation may be carried out in parallel, repeatedly, or heuristically. In an embodiment, at least one operation may be omitted or an additional operation may be added.

The server 100 according to the present disclosure may perform a payment support method according to various embodiments of the present disclosure. The payment support method according to the embodiment of the present disclosure may include acquiring sales information, invitation information and first payment information from a first terminal 220 (S1410); requesting a payment server 130 to process a first payment based on the first payment information (S1420); delivering the sales information and payment status information to a shop terminal 140 and terminals of the remaining users 250, and delivering the payment status information to the first terminal 220 (S1430); acquiring second payment information from a second terminal 240 (S1440); requesting the payment server 130 to process a second payment based on the second payment information (S1450); updating and delivering the payment status information to the shop terminal 140 and terminals of a plurality of users 200 (S1460); delivering a first notification indicating that the payment of a total amount to be paid is completed to the shop terminal 140 and the terminals of the plurality of users 200 (S1470); acquiring a second notification indicating that the payment completion for the total amount to be paid is confirmed from the shop terminal 140 (S1480); and/or delivering a third notification indicating that the payment completion for the total amount to be paid is confirmed to the terminals of the plurality of users 200 (S1490).

In operation S1410, one or more processors 410 of the server 100 may acquire sales information indicating a corresponding shop, an identifier for identifying a group of the plurality of users 200, and a total amount to be paid, invitation information for identifying the remaining users 250, and first payment information indicating a first payment amount from the first terminal.

In operation S1420, the one or more processors 410 may request the payment server 130 to process the first payment of the first payment amount by the first user 210 based on the first payment information. In operation S1430, according to a response from the payment server 130 indicating that the first payment has been approved, the one or more processors 410 may deliver payment status information for the total amount to be paid and the sales information to the shop terminal 140 and each of the terminals of the remaining users 250, and may deliver the payment status information to the first terminal 220.

In operation S1440, the one or more processors 410 may acquire the second payment information indicating the second payment amount from the second terminal 240 of the second user 230. In operation S1450, the one or more processors 410 may request the payment server 130 to process the second payment of the second payment amount by the second user 230 based on the second payment information. In operation S1460, according to a response from the payment server 130 indicating that the second payment has been approved, the one or more processors 410 may update the payment status information, and may deliver the updated payment status information to the shop terminal 140 and each of the terminals of the plurality of users 200.

In operation S1470, when the payment of the total amount to be paid is completed, the one or more processors 410 may deliver the first notification to the shop terminal 140 and the terminals of the plurality of users 200. In operation S1480, the one or more processors 410 may acquire the second notification from the shop terminal 140. In operation S1490, the one or more processors 410 may deliver the third notification to each of the terminals of the plurality of users 200 according to the second notification.

In an embodiment, the one or more processors 410 may acquire designated-user information related to at least one of a payment number condition, a payment amount condition, and a payment frequency condition of a designated user from the shop terminal 140. Also, the one or more processors 410 may acquire user identification information of at least one of the plurality of users 200 from at least one of the first terminal 220, the second terminal 240 and the invitation information. The one or more processors 410 may acquire payment history information 520 for the shop of at least one of the plurality of users 200 from one or more memories 420 based on the user identification information. Also, the one or more processors 410 may determine at least one of the plurality of users 200 as a designated user corresponding to the shop based on the designated-user information 510 and the payment history information 520.

In an embodiment, the one or more processors 410 may acquire, from the shop terminal 140, information relating to a product of the shop that corresponds to the total amount to be paid. Also, the one or more processors 410 may deliver, to a terminal of the designated user, coupon information of the shop that relates to the product.

In an embodiment, the one or more processors 410 may acquire information indicating a first application probability, a first discount rate, a second application probability and a second discount rate from the shop terminal 140. In the process of requesting of the payment server 130 to process the second payment (S1450), in response to the acquisition of the second payment information, the one or more processors 410 may apply the first discount rate to the second payment amount according to the first application probability when the second user 230 is not a designated user, and may apply the second discount rate to the second payment amount according to the second application probability when the second user 230 is a designated user. Also, the one or more processors 410 may request the payment server 130 to process a payment of the second payment amount to which the first discount rate or the second discount rate is applied.

In an embodiment, the one or more processors 410 may acquire, from a third terminal of a third user among the remaining users 250, third payment information indicating a third payment amount. The one or more processors 410 may request the payment server 130 to process the third payment of the third payment amount based on the third payment information. According to a response from the payment server 130 indicating that the third payment has been approved within a predetermined time interval from an approval time of the second payment, the one or more processors 410 may compare the sum amount of the second payment amount and the third payment amount to a remaining unpaid amount.

In an embodiment, when the sum amount exceeds the remaining unpaid amount, the one or more processors 410 may cancel a payment based on a cancelation criterion predetermined by the first user 210. For example, the one or more processors 410 may deliver a request to cancel the third payment to the payment server 130, or may deliver a request to cancel the second payment and the third payment to the payment server 130. Also, the one or more processors 410 may deliver, to the payment server 130, a request to cancel a payment of a smaller payment amount selected from between the second payment and the third payment, or may deliver a request to cancel portions of the second payment and third payment to the payment server 130 according to a ratio of the remaining unpaid amount to the sum amount.

In an embodiment, the one or more processors 410 may acquire, from the third terminal of the third users, the third payment information indicating the third payment amount and may request the payment server 130 to process the third payment of the third payment amount. Also, the one or more processors 410 may acquire, from a fourth terminal of a fourth user, fourth payment information indicating a fourth payment amount. The one or more processors 410 may request the payment server 130 to process the fourth payment of the fourth payment amount based on the fourth payment information. According to a response from the payment server 130 indicating that the third payment and the fourth payment have been approved within a predetermined time interval from an approval time of the second payment, the one or more processors 410 may compare the sum amount of the second payment amount, the third payment amount and the fourth payment amount to the remaining unpaid amount. When the sum amount exceeds the remaining unpaid amount, the one or more processors 410 may determine whether the sum amount minus at least one amount selected from among the second payment amount, the third payment amount and the fourth payment amount matches the remaining unpaid amount. According to the determination that the sum amount minus the selected amount matches the remaining unpaid amount, the one or more processors 410 may deliver a request to cancel at least one payment corresponding to the selected amount to the payment server 130.

The user terminals (e.g., the first terminal 220, the second terminal 240, etc.) and the shop terminal 140 may perform operations corresponding to the payment support method performed by the above-described server 100 based on the payment support technique according to the present disclosure.

The various embodiments of the present disclosure may be implemented in software recorded in a machine-readable recording medium. The software may be software for implementing the above-described various embodiments of the present disclosure. The software may be inferred from the various embodiments of the present disclosure by programmers in the art to which the present disclosure belongs. For example, the software may be commands (e.g., code or code segments) or a program that is readable by a machine. The machine may be an apparatus operable according to a command called from a recording medium and may be, for example, a computer. In an embodiment, the machine may be the server 100 according to the embodiments of the present disclosure. In an embodiment, a processor of the machine may execute a called command to enable components of the machine to perform a function corresponding to the relevant command. In an embodiment, the processor may be provided as the one or more processors 410 according to the embodiments of the present disclosure. The recording medium may refer to any kind of machine-readable recording medium where data is stored. Examples of the recording medium include a read-only memory (ROM), a random-access memory (RAM), a CD-ROM, a magnetic tape, a floppy disk, an optical data storage device, and the like. In an embodiment, the recording medium may be the one or more memories 420. In an embodiment, the recording medium may be implemented by being distributed to computer systems or the like connected through a network. The software may be distributed to and stored and executed in computer systems or the like. The recording medium may be a non-transitory recording medium. The non-transitory recording medium may refer to a tangible medium regardless of whether data is stored semi-permanently or temporarily and does not include signals propagating in a transitory manner.

The payment support technique according to the present disclosure can reduce operational burden on each of a plurality of users when proceeding with partial payments by the plurality of users. In general, a user terminal (e.g., a smartphone), which is designed by considering portability, may have lower computational performance than a computing system such as a server. In consideration of this, the payment support technique according to the present disclosure can be designed to minimize computation on a user terminal and to perform most computation on a server. Specifically, in the payment support technique according to the present disclosure, each user terminal does not need to directly interact with other user terminals or directly transmit or receive order information to or from a shop terminal in order to adjust shared amounts. Meanwhile, on behalf of a user terminal, the server may deliver information between another user terminal, a payment server, and a shop terminal, and perform an operation of automatically canceling a payment in case of overpayment to reduce operational burden on a user terminal.

According to the present disclosure in some embodiments, when paying in a food service shop, it is possible to reduce the inconvenience of waiting in line at a checkout counter of the shop or the inconvenience of waiting at a table where people have eaten for a long time until a clerk processes a payment.

According to the present disclosure in some embodiments, when paying by bill splitting, it is possible to reduce the amount of time spent by dividing the total payment into individual amounts to be paid or by repeating a payment several times according to the individual amounts.

While the foregoing methods have been described with respect to particular embodiments, these methods may also be implemented as computer-readable code on a computer-readable recording medium. The computer-readable recoding medium includes any kind of data storage devices that can be read by a computer system. Examples of the computer-readable recording medium include ROM, RAM, CD-ROM, magnetic tape, floppy disk, optical data storage device and the like. Also, the computer-readable recoding medium can be distributed to the computer systems which are connected through a network so that the computer-readable code can be stored and executed in a distribution manner. Further, the functional programs, code and code segments for implementing the foregoing embodiments can easily be inferred by programmers in the art to which the present disclosure pertains.

While certain embodiments have been described, these embodiments have been presented by way of example only and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A server for supporting payments of a total amount to be paid which is spent in an offline shop by a plurality of users, the server comprising:
one or more processors; and
one or more memories storing commands that cause the one or more processors to perform an operation when the commands are executed by the one or more processors,
wherein the one or more processors are configured to:
acquire, from a first terminal of a first user among the plurality of users, sales information indicating the shop, an identifier for identifying a group of the plurality of users, and the total amount to be paid, invitation information for identifying the remaining users excluding the first user among the plurality of users, and first payment information indicating a first payment amount corresponding to a portion of the total amount to be paid;
request a payment server to process a first payment of the first payment amount by the first user based on the first payment information;
deliver the sales information and payment status information for the total amount to be paid to a shop terminal of the shop and terminals of the remaining users, and deliver the payment status information to the first terminal according to a response from the payment server indicating that the first payment has been approved, wherein the payment status information indicates a total paid amount or a total remaining unpaid amount out of the total amount to be paid;
acquire second payment information indicating a second payment amount corresponding to a portion of the remaining unpaid amount out of the total amount to be paid from a second terminal of a second user among the remaining users;
request the payment server to process a second payment of the second payment amount by the second user based on the second payment information;
update and deliver the payment status information to the shop terminal and the terminals of the plurality of users according to a response from the payment server indicating that the second payment has been approved;
deliver a first notification indicating that a payment of the total amount to be paid has been completed to the shop terminal and the terminals of the plurality of users when the payment of the total amount to be paid is completed;
acquire a second notification indicating that a payment completion for the total amount to be paid is confirmed from the shop terminal; and
deliver a third notification indicating that the payment completion for the total amount to be paid is confirmed to the terminals of the plurality of users upon a receipt of the second notification.

2. The server of claim 1, wherein the one or more processors are further configured to:
deliver a notification indicating that the first payment has been completed to the first terminal according to a response from the payment server indicating that the first payment has been approved; and
deliver a notification indicating that the second payment has been completed to the second terminal according to a response from the payment server indicating that the second payment has been approved.

3. The server of claim 1, wherein the one or more processors are further configured to:
acquire, from the shop terminal, designated-user information for identifying a designated user;
acquire, from at least one of the first terminal, the second terminal and the invitation information, user identification information for at least one of the plurality of users; and
determine the designated user corresponding to the shop among the plurality of users based on the designated-user information and the user identification information.

4. The server of claim 1, wherein the one or more processors are further configured to:
acquire, from the shop terminal, designated-user information related to at least one of a payment number condition, a payment amount condition, and a payment frequency condition of a designated user;
acquire, from at least one of the first terminal, the second terminal, and the invitation information, user identification information for at least one of the plurality of users;
acquire, from the one or more memories, payment history information for the shop of the at least one of the plurality of users based on the user identification information; and
determine the designated user corresponding to the shop among the plurality of users based on the payment history information and the designated-user information.

5. The server of claim 4, wherein the one or more processors are further configured to:
acquire, from the shop terminal, information relating to a product of the shop that corresponds to the total amount to be paid; and
deliver, to a terminal of the designated user, coupon information of the shop that relates to the product.

6. The server of claim 4, wherein the one or more processors are further configured to:
acquire, from the shop terminal, information indicating a first application probability, a first discount rate, a second application probability higher than the first application probability, and a second discount rate higher than the first discount rate to apply a discount to a payment amount for the shop;
in response to the acquisition of the second payment information, apply the first discount rate to the second payment amount according to the first application probability when the second user is not the designated user, and apply the second discount rate to the second payment amount according to the second application probability when the second user is the designated user; and
request the payment server to process a payment of the second payment amount to which the first discount rate or the second discount rate is applied.

7. The server of claim 1, wherein the one or more processors are further configured to:
acquire, from a third terminal of a third user among the remaining users, third payment information indicating a third payment amount corresponding to a portion of the remaining unpaid amount;
request the payment server to process a third payment of the third payment amount based on the third payment information; and
compare a sum amount of the second payment amount and the third payment amount to the remaining unpaid amount, according to a response from the payment server indicating that the third payment has been approved within a predetermined time interval from an approval time of the second payment.

8. The server of claim 7, wherein the one or more processors are further configured to:
deliver the first notification to the shop terminal and the terminals of the plurality of users when the sum amount matches the remaining unpaid amount.

9. The server of claim 7, wherein, when the sum amount exceeds the remaining unpaid amount, the one or more processors are further configured to:
deliver a request to cancel the third payment to the payment server;
deliver a request to cancel the second payment and the third payment to the payment server;
deliver a request to cancel a payment of a smaller payment amount selected from between the second payment and the third payment to the payment server; or
deliver a request to cancel portions of the second payment and the third payment to the payment server according to a ratio of the remaining unpaid amount to the sum amount, based on a cancelation criterion predetermined by the first user.

10. The server of claim 1, wherein the one or more processors are further configured to:
acquire, from a third terminal of a third user among the remaining users, third payment information indicating a third payment amount corresponding to a portion of the remaining unpaid amount;
request the payment server to process a third payment of the third payment amount based on the third payment information;
acquire, from a fourth terminal of a fourth user among the remaining users, fourth payment information indicating a fourth payment amount corresponding to a portion of the remaining unpaid amount;
request the payment server to process a fourth payment of the fourth payment amount based on the fourth payment information;
compare a sum amount of the second payment amount, the third payment amount, and the fourth payment amount to the remaining unpaid amount, according to a response from the payment server indicating that the third payment and the fourth payment have been approved within a predetermined time interval from an approval time of the second payment;
determine whether the sum amount minus at least one amount selected from among the second payment amount, the third payment amount, and the fourth payment amount matches the remaining unpaid amount, when the sum amount exceeds the remaining unpaid amount; and
upon determining that the sum amount minus the selected amount matches the remaining unpaid amount, deliver, to the payment server, a request to cancel at least one payment corresponding to the selected amount.

11. The server of claim 1, wherein the one or more processors are further configured to:
acquire user information of the second user from the second terminal;
acquire, from the payment server based on the user information, payment method information indicating information regarding a credit card of the second user;
register the payment method information and the user information of the second user in the one or more memories; and
request the payment server to process the second payment based on the payment method information and the second payment information acquired from the second terminal.

12. The server of claim 1, wherein the one or more processors are further configured to:
acquire, from the second terminal, payment method information indicating information regarding a credit card of the second user and the second payment information; and
request the payment server to process the second payment based on the second payment information and the payment method information.

13. A method for supporting payments of a total amount to be paid which is spent in an offline shop by a plurality of users, and performed in a server including one or more processors and one or more memories storing commands that cause the one or more processors to perform an operation when the commands are executed by the one or more processors, the method comprising:
acquiring, from a first terminal of a first user among the plurality of users, sales information indicating the shop, an identifier for identifying a group of the plurality of users, and the total amount to be paid, invitation information for identifying the remaining users excluding the first user among the plurality of users, and first payment information indicating a first payment amount corresponding to a portion of the total amount to be paid;
requesting a payment server to process a first payment of the first payment amount by the first user based on the first payment information;
delivering the sales information and payment status information for the total amount to be paid to a shop terminal of the shop and terminals of the remaining users, and delivering the payment status information to the first terminal according to a response from the payment server indicating that the first payment has been approved, wherein the payment status information indicates a total paid amount or a total remaining unpaid amount out of the total amount to be paid;
acquiring second payment information indicating a second payment amount corresponding to a portion of the remaining unpaid amount out of the total amount to be paid from a second terminal of a second user among the remaining users;
requesting the payment server to process a second payment of the second payment amount by the second user based on the second payment information;
updating and delivering the payment status information to the shop terminal and the terminals of the plurality of users according to a response from the payment server indicating that the second payment has been approved;
delivering a first notification indicating that a payment of the total amount to be paid has been completed to the shop terminal and the terminals of the plurality of users when the payment of the total amount to be paid has been completed;
acquiring a second notification indicating that a payment completion for the total amount to be paid is confirmed from the shop terminal; and
delivering a third notification indicating that the payment completion for the total amount to be paid is confirmed to the terminals of the plurality of users upon a receipt of the second notification.

14. The method of claim 13, wherein the method further comprises:
acquiring, from the shop terminal, designated-user information related to at least one of a payment number condition, a payment amount condition, and a payment frequency condition of a designated user;
acquiring, from at least one of the first terminal, the second terminal, and the invitation information, user identification information for at least one of the plurality of users;
acquiring, from the one or more memories, payment history information for the shop of at least one of the plurality of users based on the user identification information; and
determining the designated user corresponding to the shop among the plurality of users based on the payment history information and the designated-user information.

15. The method of claim 14, wherein the method further comprises:
acquiring, from the shop terminal, information relating to a product of the shop that corresponds to the total amount to be paid; and
delivering, to a terminal of the designated user, coupon information of the shop that relates to the product.

16. The method of claim 14, wherein the method further comprises:
acquiring, from the shop terminal, information indicating a first application probability, a first discount rate, a second application probability higher than the first application probability, and a second discount rate higher than the first discount rate to apply a discount to a payment amount for the shop,
wherein requesting the payment server to process the second payment comprises:
in response to the acquisition of the second payment information, applying the first discount rate to the second payment amount according to the first application probability when the second user is not the designated user, and applying the second discount rate to the second payment amount according to the second application probability when the second user is the designated user; and
requesting the payment server to process a payment of the second payment amount to which the first discount rate or the second discount rate is applied.

17. The method of claim 13, wherein the method further comprises:
acquiring, from a third terminal of a third user among the remaining users, third payment information indicating a third payment amount corresponding to a portion of the remaining unpaid amount;
requesting the payment server to process a third payment of the third payment amount based on the third payment information; and
comparing a sum amount of the second payment amount and the third payment amount to the remaining unpaid amount, according to a response from the payment server indicating that the third payment has been approved within a predetermined time interval from an approval time of the second payment.

18. The method of claim 17, wherein, when the sum amount exceeds the remaining unpaid amount, the method further comprises:
delivering a request to cancel the third payment to the payment server;
delivering a request to cancel the second payment and the third payment to the payment server;
delivering a request to cancel a payment of a smaller payment amount selected from between the second payment and the third payment to the payment server; or
delivering a request to cancel portions of the second payment and the third payment to the payment server according to a ratio of the remaining unpaid amount to the sum amount, based on a cancelation criterion predetermined by the first user.

19. The method of claim 13, wherein the method further comprises:
acquiring, from a third terminal of a third user among the remaining users, third payment information indicating a third payment amount corresponding to a portion of the remaining unpaid amount;
requesting the payment server to process a third payment of the third payment amount based on the third payment information;
acquiring, from a fourth terminal of a fourth user among the remaining users, fourth payment information indicating a fourth payment amount corresponding to a portion of the remaining unpaid amount;
requesting the payment server to process a fourth payment of the fourth payment amount based on the fourth payment information;
comparing a sum amount of the second payment amount, the third payment amount, and the fourth payment amount to the remaining unpaid amount, according to a response from the payment server indicating that the third payment and the fourth payment have been approved within a predetermined time interval from an approval time of the second payment;
determining whether the sum amount minus at least one amount selected from among the second payment amount, the third payment amount, and the fourth payment amount matches the remaining unpaid amount, when the sum amount exceeds the remaining unpaid amount; and
upon determining that the sum amount minus the selected amount matches the remaining unpaid amount, delivering, to the payment server, a request to cancel at least one payment corresponding to the selected amount.

20. A non-transitory computer-readable recording medium storing commands that cause one or more processors to perform an operation when the commands are executed by the one or more processors in a server for supporting payments of a total amount to be paid which is spent in an offline shop by a plurality of users, the commands comprising:
acquiring, from a first terminal of a first user among the plurality of users, sales information indicating the shop, an identifier for identifying a group of the plurality of users, and the total amount to be paid, invitation information for identifying the remaining users excluding the first user among the plurality of users, and first payment information indicating a first payment amount corresponding to a portion of the total amount to be paid;
requesting a payment server to process a first payment of the first payment amount by the first user based on the first payment information;
delivering the sales information and payment status information for the total amount to be paid to a shop terminal of the shop and terminals of the remaining users, and delivering the payment status information to the first terminal according to a response from the payment server indicating that the first payment has been approved, wherein the payment status information indicates a total paid amount or a total remaining unpaid amount out of the total amount to be paid;
acquiring second payment information indicating a second payment amount corresponding to a portion of the remaining unpaid amount out of the total amount to be paid from a second terminal of a second user among the remaining users;
requesting the payment server to process a second payment of the second payment amount by the second user based on the second payment information;
updating and delivering the payment status information to the shop terminal and the terminals of the plurality of users according to a response from the payment server indicating that the second payment has been approved;
delivering a first notification indicating that a payment of the total amount to be paid is completed to the shop terminal and the terminals of the plurality of users when the payment of the total amount to be paid is completed;
acquiring a second notification indicating that a payment completion for the total amount to be paid is confirmed from the shop terminal; and
delivering a third notification indicating that the payment completion for the total amount to be paid is confirmed to the terminals of the plurality of users upon a receipt of the second notification.
